(19) United States
(12) Patent Application Publication
(10) Pub. No.: US 2009/0316612 A1
(43) Pub. Date: Dec. 24, 2009

(54) Single Cable Antenna Module for Laptop Computer and Mobile Devices

(75) Inventors: Gregory Poilasne, El Cajon, CA (US); Maha Achour, San Diego, CA (US); Ajay Gummalla, San Diego, CA (US); Vaneet Pathak, San Diego, CA (US); Ryan Robert Bartsch, Alpine, CA (US); Angela Mae Dodd, Oceanside, CA (US)

Correspondence Address: FISH & RICHARDSON, PC, P.O. BOX 1022, MINNEAPOLIS, MN, 55440-1022, US

(73) Assignee: Rayspan Corporation

(21) Appl. No.: 12/431,689

(22) Filed: Apr. 28, 2009

Related U.S. Application Data
(60) Provisional application No. 61/050,954, filed on May 6, 2008.

(51) Int. Cl. H04L 5/00; H04W 4/00

(52) U.S. Cl. 370/297; 370/329

(57) ABSTRACT

Implementations and examples of wireless communication systems based on multi-frequency antennas each operating at different frequency bands for wireless communications, including multi-frequency antennas based on metamaterial structures.

### PRIORITY CLAIM AND RELATED APPLICATION

This patent document claims the benefits of U.S. Provisional Patent Application Ser. No. 61/050,954 entitled “Single Cable Antenna Module for Laptop Computer and Mobile Devices” and filed on May 6, 2008. The entire disclosure of the above application is incorporated by reference as part of the disclosure of this document.

### BACKGROUND

This document relates to RF antennas and their implementations in wireless communication devices such as computers and mobile devices.

RF antennas can be used to provide wireless communications in various equipment and devices such as computers (e.g., laptop computers) and portable devices with wireless communication capabilities. For example, RF antennas can be coupled to peripheral component interface (PCI) cards in a laptop computer or other mobile devices to provide wireless communications.

### SUMMARY

Implementations and examples of wireless communication systems are provided based on multi-frequency antennas each operating at different frequency bands for wireless communications, including multi-frequency antennas based on metamaterial structures.

In one aspect, a wireless communication system is provided to include a first peripheral component interface (PCI) card for wireless communications in a first RF frequency band; a second PCI card for wireless communications in a second RF frequency band different from the first RF frequency band; an antenna structured to operate at the first and second RF frequency bands; and a signal router. The signal router is coupled between the antenna and the first and second PCI cards to direct a communication signal from the antenna in the first RF frequency band to the first PCI card and a communication signal from the antenna in the second RF frequency band to the second PCI card, and to direct a communication signal from the first PCI card in the first RF frequency band to the antenna and a communication signal from the second PCI card in the second RF frequency band to the antenna. This system includes a single cable connected between the antenna and signal router to transmit communication signals in both the first and second RF frequency bands between the antenna and the signal router.

In another aspect, an antenna system is provided and configured to be coupled to first and second PCIs in a computer. This system includes an antenna; first, second, and third cables; and a diplexer. The first cable couples the antenna and the diplexer, the second cable couples the diplexer and the first PCI, and the third cable couples the diplexer and the second PCI.

In another aspect, an antenna system is provided and is configured to be coupled to three or more PCIs in a computer.

This system includes an antenna; a switchplexer; a main cable coupling the antenna and the switchplexer; and three or more secondary cables, each coupling the switchplexer and each of the three or more PCIs. The antenna operates for three or more frequency ranges corresponding to applications associated with the three or more PCIs, respectively, and the three or more secondary cables carry signals for the three or more frequency ranges, respectively.

In yet another aspect, an antenna system is provided and is configured to be coupled to a PCI wherein wireless wide area network (WWAN) and wireless local area network (WLAN) functions are integrated. This system includes an antenna that operates for a first frequency range associated with WLAN applications and a second frequency range associated with WWAN applications; a cable; and a diplexer. The cable couples the antenna and the diplexer, which is integrated in the PCI.

These and other aspects and associated implementations and their variations are described in detail in the attached drawings, the detailed description and the claims.

### BRIEF DESCRIPTION OF THE DRAWINGS

FIG. 1 illustrates an example of a laptop computer equipped with a wireless communication system in a two-antenna and dual-cable configuration;

FIG. 2 illustrates an example of a system with wireless local area network (WLAN) mini PCI and wireless wide area network (WWAN) mini PCI;

FIG. 3 illustrates a table of an isolation target specifications between two antennas in each strip in FIG. 2;

FIG. 4 illustrates an example of a laptop computer equipped with a wireless communication system in a universal-antenna single-cable configuration;

FIG. 5 illustrates an example of a single layer universal antenna structure;

FIG. 6 illustrates the measured return loss of the single layer universal antenna structure shown in FIG. 5;

FIG. 7 illustrates the measured efficiency of the single layer universal antenna structure shown in FIG. 5;

FIG. 8 illustrates structures of the single layer universal antenna related to tuning low bands for the design in FIG. 5;

FIG. 9 illustrates structures of the single layer universal antenna related to tuning mid bands for the design in FIG. 5;

FIG. 10 illustrates structures of the single layer universal antenna related to tuning upper mid bands for the design in FIG. 5;

FIG. 11 illustrates structures of the single layer universal antenna related to tuning high bands for the design in FIG. 5;

FIGS. 12A-12D illustrate the top, perspective and cross-sectional views of a multi layer universal antenna structure;

FIG. 13 illustrates the measured return loss of the low, mid and high bands of the multi layer universal antenna structure shown in FIG. 12A-12D;

FIG. 14 illustrates the measured return loss before tuning of the multi layer universal antenna structure shown in FIG. 12A-12D;

FIG. 15 illustrates the measured return loss after tuning of the multi layer universal antenna structure shown in FIG. 12A-12D;

FIG. 16 illustrates an example of a wireless communication system in a universal-antenna single-cable and diplexer configuration;

FIG. 17 illustrates a functional block diagram of a WAN/LAN diplexer;

FIGS. 18A-18B illustrates a Low-Band Band-Pass Filter using one E-CRLH unit cell and 3-cell Low-Pass filter; (a) Circuit layout with pads for components, (b) Picture of preliminary fabricated prototype;

FIGS. 19A-19B illustrates a Transmission (S12) and return loss (S11/S22) for the Low-Band Band-Pass Filter; (a) Simulation from FIG. 18A, (b) Measured from FIG. 18B;

FIG. 20 illustrates a High-Band Band-Pass Filter using one E-CRLH unit cell and 3-cell High-Pass filter;

FIG. 21 illustrates a simulated transmission (S12) and return loss (S11/S22) for the Low-Band Band-Pass Filter in FIG. 20;

FIG. 22 illustrates a 3-port diplexer combining both Low-Pass and High-pass band-Pass filters in FIGS. 18A-18B and 19A-19B, respectively;

FIG. 23 illustrates simulated transmission S12 and S13 as well as coupling between Port 2 and Port 3 for the High-Band Low-Band Diplexer in FIG. 22;

FIG. 24 illustrates an example of a wireless communication system in a universal-antenna single-cable configuration with three PCIs; and

FIG. 25 illustrates an example of a wireless communication system in a universal-antenna single-cable configuration with an integrated PCI to provide WLAN, WWAN and diplexers.

### DETAILED DESCRIPTION

Metamaterial technology can be employed to fabricate universal antennas that operate in two or more frequency bands and diplexers in devices with wireless communication capabilities such as laptop computers and other portable devices. The advantages of using metamaterials for these devices include compact size, reduced cost in material and manufacture and enhanced performance in reception and transmission of wireless signals.

The propagation of electromagnetic waves in most materials obeys the right handed rule for the (E, H, λ) vector fields, where E is the electrical field, H is the magnetic field, and λ is the wave vector. The phase velocity direction is the same as the direction of the signal energy propagation (group velocity) and the refractive index is a positive number. Such materials are “right handed” (RH). Most natural materials are RH materials. Artificial materials can also be RH materials.

A metamaterial has an artificial structure. When designed with a structural average unit cell size p much smaller than the wavelength of the electromagnetic energy guided by the metamaterial, the metamaterial is like a homogeneous medium to the guided electromagnetic energy. Unlike RH materials, a metamaterial can exhibit a negative refractive index with permittivity ∈ and permeability μ being simultaneously negative, and the phase velocity direction is opposite to the direction of the signal energy propagation where the relative directions of the (E, H, λ) vector fields follow the left handed rule. Metamaterials that support only a negative index of refraction with permittivity ∈ and permeability μ being simultaneously negative are “left handed” (LH) metamaterials.

Many metamaterials are mixtures of LH metamaterials and RH materials and thus are Composite Left and Right Handed (CRLH) metamaterials. A CRLH metamaterial can behave like a LH metamaterial at low frequencies and a RH material at high frequencies. Certain device designs based on various CRLH metamaterials are described in, Caloz and Itoh, “Electromagnetic Metamaterials: Transmission Line Theory and Microwave Applications,” John Wiley & Sons (2006). Examples for CRLH metamaterials and their applications in antennas can be found in “Invited paper: Prospects for Metamaterials” by Tatsuo Itoh in Electronics Letters, Vol. 40, No. 16 (August, 2004).

CRLH metamaterials can be structured and engineered to exhibit electromagnetic properties that are tailored for specific applications and is used in applications where it is difficult, impractical or infeasible to use other materials. In addition, CRLH metamaterials can be used to develop new applications and to construct new devices that may not be possible with RH materials. MTM antenna and/or diplexer designs presented herein may be implemented by using conventional FR-4 printed circuit boards. Examples of other fabrication techniques include thin film fabrication technique, system on chip (SOC) technique, low temperature co-fired ceramic (LTCC) technique, and monolithic microwave integrated circuit (MMIC) technique. Examples of antennas and other devices based on metamaterials are described in U.S. patent application Ser. No. 11/741,674 entitled “Antennas, Devices and Systems based on Metamaterial Structures” filed on Apr. 27, 2007 and U.S. patent application Ser. No. 11/844,982 entitled “Antennas Based on Metamaterial Structures” filed on Aug. 24, 2007, which are incorporated by reference as part of the disclosure of this document.

For MTM based antennas, a change in the MTM structure can affect the frequencies of the resonance modes and impedance matching of resonant modes of the antenna. In particular, the antenna resonances are affected by the presence of one or more left handed modes of the MTM structure. Such left handed modes can excite and better match the lowest resonance and improve the impedance matching of higher resonances. The examples provided in this document illustrate some methods for fine tuning the MTM structure to optimize the antenna design and meet specification requirements. More specifically, the techniques and designs described in this document use MTM structures to form antennas and diplexers and can be applied to devices equipped with mini PCIs operating in different frequency ranges or bands, e.g., three or more frequency bands. Laptop computers and other mobile devices can use a mini peripheral component interface (mini PCI) card which is configured to operate at 32 MHz with a 32 bit bus. Laptop computers may include two types of mini PCIs: WLAN mini PCI and WWAN mini PCI. Some laptop computers may include a third PCI to operate at additional frequencies, e.g., Bluetooth and/or Ultra Wide Band (UWB).

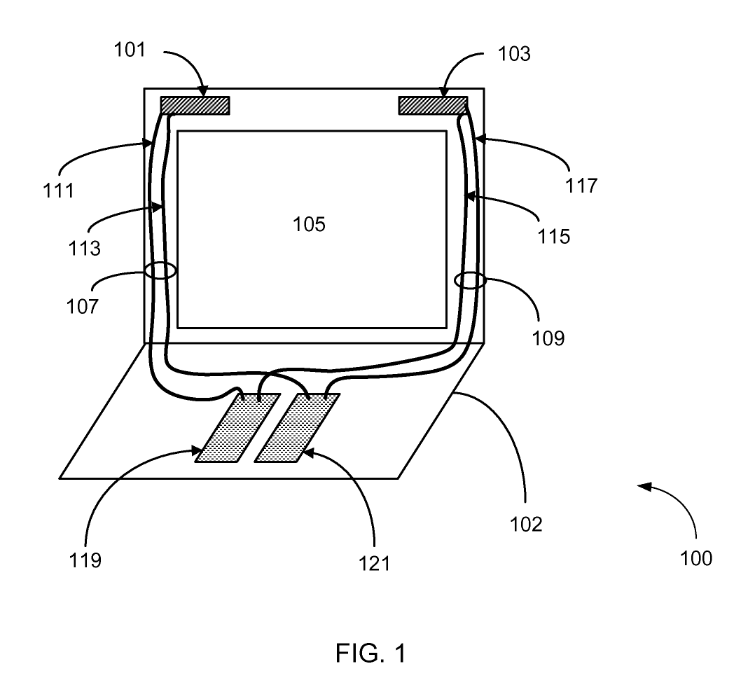

FIG. 1 illustrates one example of a laptop computer 100 having mini PCIs 119 and 121 and two antenna structures or strips 101 and 103. In this example, each of the two antenna strips 101 and 103 includes two antennas for transmitting and receiving wireless communication signals over two separate bands e.g., WWAN and WLAN). The laptop computer 100 includes a base 102 on which the two or more PCIs 119 and 121 are located and a laptop screen monitor 105 that is connected to the base 102. The two antenna strips 101 and 103 are respectively located at top right and top left locations above the laptop screen monitor 105. The left antenna strip 101 and right antenna strip 103 are each connected to a pair of left cables 107 and a pair of right cables 109, respectively. In this example, the left cables 107 include two left cable 111 and left cable 113, the right cables 109 include two right cable 115 and right cable 117. The left cable 111 and right cable 115 are each connected to the WLAN mini PCI 119; and the left cable 113 and right cable 117 are each connected to the WWAN mini PCI 121. These cables may be implemented using coaxial cables or other types of RF cables. Two cables 107 or 109 run along each side of the monitor screen 105 to the two mini PCIs 119 and 121 located at the base 102 of the laptop 100. The presence of four bulky cables 107 and 109 requires some space in the bezel region of the monitor screen 105 to accommodate the cables 107 and 109 and thus can interfere with minimization of the bezel region of the monitor screen 105.

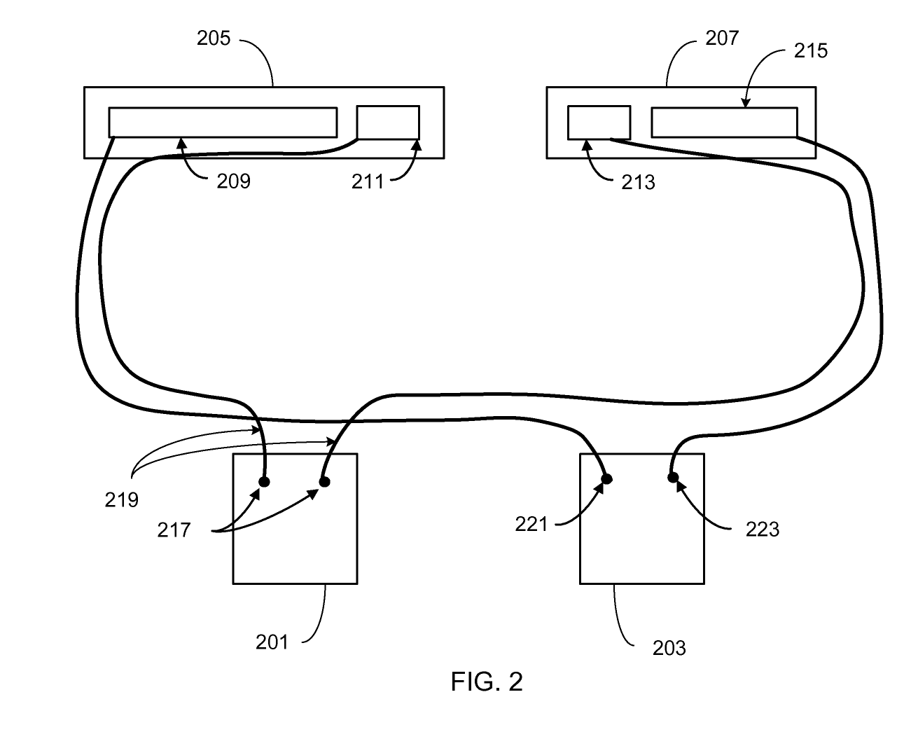

FIG. 2 shows a specific implementation of the wireless communication setup in FIG. 1 in a laptop computer that has both WLAN mini PCI 201 and WWAN mini PCI 203 for wireless communications. Two antenna strips, the left antenna strip 205 and the right antenna strip 207, are provided and connected to the PCIs 201 and 203. The left strip 205 includes two antennas 209 and 211. Similar to the design in FIG. 1, the PCIs 201 and 203 may be located in the base of the laptop computer and the antenna strips 205 and 207 may be located on the peripheral regions of the laptop monitor screen. The antenna 209 is configured and operated to provide transmission and reception (TX/RX) of signals in the frequency range from 700 MHz to 2170 MHz for WWAN applications. The other antenna 211 is configured and operated to provide transmission and reception (TX/RX) of signals in another frequency range from 2300 MHz to 5825 MHz for WLAN/WiMAX applications. Similarly, the right antenna strip 207 includes two antennas 215 and 213. Like the antenna 211 located in the left strip 205, the antenna 213 transmits and receives signals in the WLAN/WiMAX frequency range from 2300 MHz to 5825 MHz for WLAN/WiMAX applications. The antenna 215, like the antenna 208, is configured and operated in the RX mode for diversity in the WWAN frequency range.

The WLAN 211 and WLAN 213, which may be identical antennas, are connected to two ports of the WLAN mini PCI 201 via two respective cables 219 and associated with the switch diversity function 217 of the WLAN mini PCI 201. Appropriate protocols, e.g., the 802.11a/b/g and/or 802.16 protocols, are implemented in the symmetric port configuration by using an internal switch. The 802.11n protocol can also be implemented for adding multiple-input multiple-output (MIMO) by internally incorporating a maximum ratio combiner (MRC), for example. The WWAN antenna 209 located in the left strip 205 is connected to a transmission and reception (TX/RX) port 221 of the WWAN mini PCI 203. The WWAN reception antenna 215 located in the right strip 207 is connected to the diversity reception (RX) port 223 of the WWAN mini PCI 203.

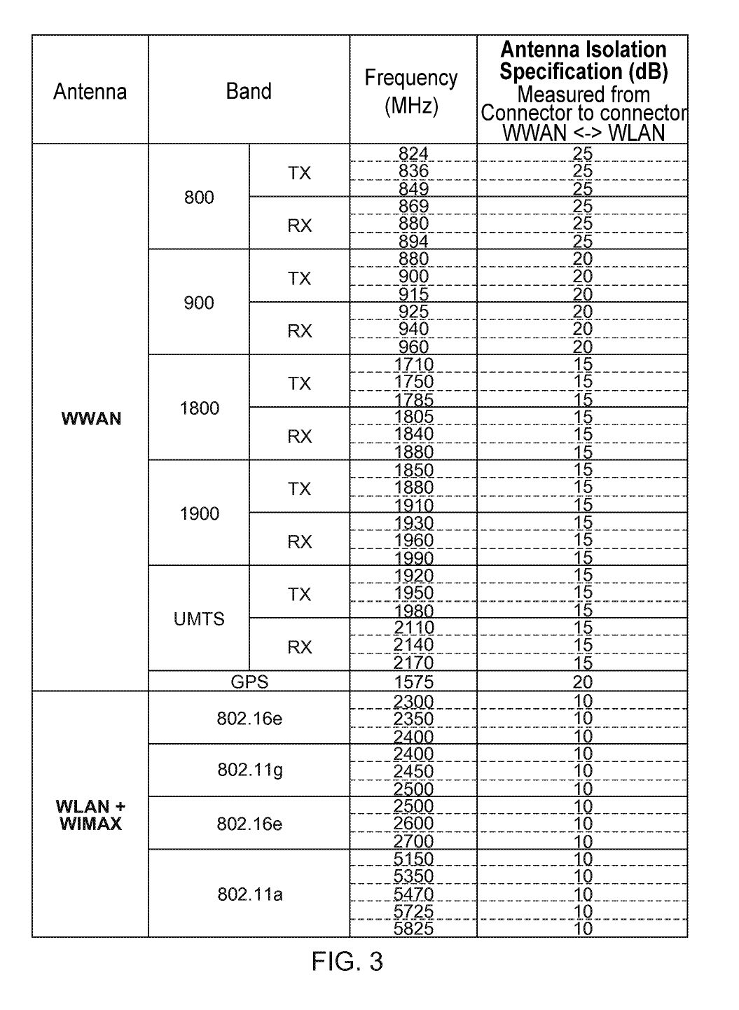

FIG. 3 shows the isolation target specifications between the two antennas in each strip in FIG. 2. The S12/S21 (dB) target values measured between the connector of the WLAN mini PCI card 201 and the connector of the WWAN mini PCI card 203 are illustrated for individual frequency bands.

The antennas may be placed at selected locations of the laptop computer to comply with certain regulatory requirements such as requirements by the Federal Communications Commission (FCC) and other requirements related to RF performance. In the arrangement shown in FIG. 1, four long cables 111, 113, 115 and 117 are needed for connecting the two sets 101 and 103 of two antennas with a total of four antennas and two mini PCI cards 119 and 121 and thus occupy precious real estate in a laptop computer. The presence of the four cables 111, 113, 115 and 117 may limit the mechanical design of the hinges that connect the mobile device display and the keyboard.

MTM structures can be used to form MTM antennas with multiple resonances and thus a single MTM antenna may be designed to operate at two or more different frequency ranges or bands to replace two or more separate antennas that are respectively operated in the two or more frequency ranges or bands.

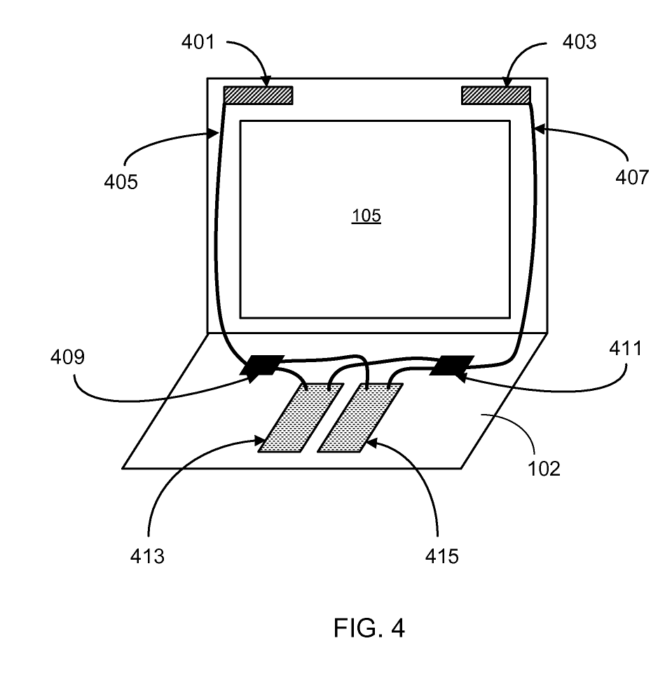

FIG. 4 illustrates an example of a laptop computer equipped with a wireless communication system based on two MTM antenna strips 401 and 403. The two MTM antenna strips 401 and 403 in this example are located on the upper left and right corners of bezels of the laptop monitor screen 105. Each strip 401 or 403 has one MTM antenna that operates in a universal frequency range covering both the WWAN and WLAN/WiMAX frequency ranges approximately from 700 MHz to 6000 MHz. Signal routers 409 and 411, WLAN mini PC 413 and WWAN mini PC 415 are located in the base 102 of the laptop computer. Each signal router 409 or 411 is provided to split signals at different frequency bands from the antenna 401 or 403 into different signals directed to their respective PCI cards for different frequency bands, respectively and to route signals from different PCI cards at different frequency bands to an antenna 401 or 403. The signal routers 409 and 411 can be signal diplexers when two PCI cards for two frequency bands are used for the wireless communications in the system in FIG. 4 and can be triplexers when three PCI cards for three frequency bands are used. Notably, because each antenna 401 or 403 operates at multiple frequency bands, a single cable is provided for feeding a universal antenna 401 or 403, and the other end of the cable is connected to a respective diplexer in the base 102. As such, the left cables 111 and 113 shown in FIG. 1 are replaced by a single cable 405 shown in FIG. 4, and right cables 115 and 117 shown in FIG. 1 are replaced by a single cable 407 shown in FIG. 4. Two diplexers 409 and 411 are provided in the base 102 of the laptop computer for routing the signals to and from the two MTM antennas 401 and 403, respectively. The diplexers 409 and 411 are connected to the WLAN mini PC 413 and WWAN mini PC 415 located in the base 102, respectively. The single left cable 405 is connected to the left diplexer 409, and the single right cable 407 is connected to the right diplexer 411. Each of the single cables 405 and 407 can be implemented in various configurations, such as a coaxial cable or a line printed on a dielectric such as a flex film.

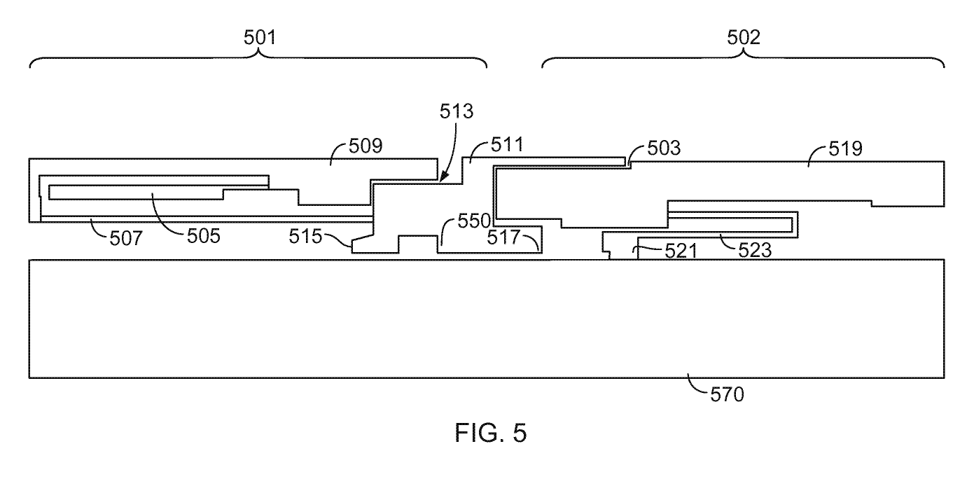

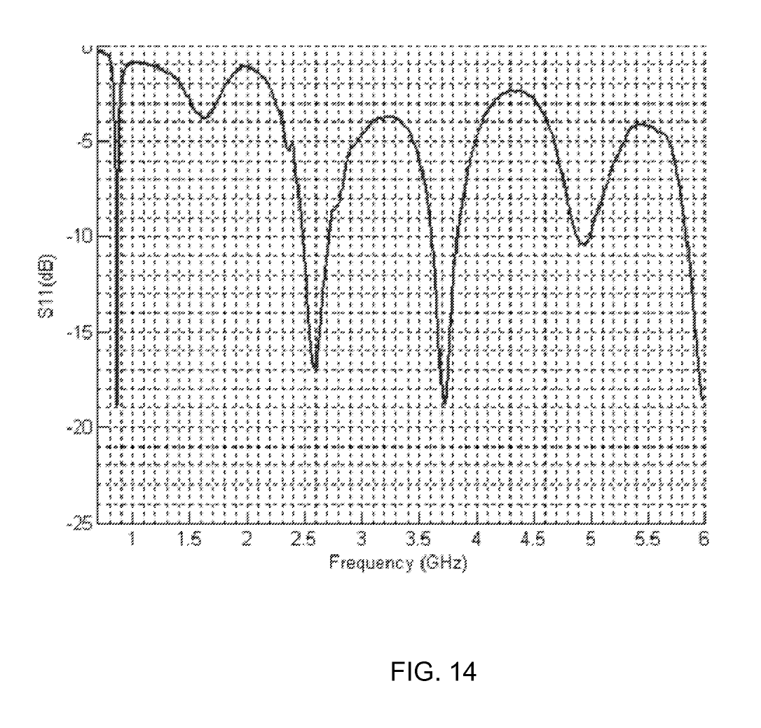

Examples of various universal antenna designs that may be used the antenna design shown in FIG. 4 are illustrated in FIGS. 5-15 and are described herein as follows.

Single Layer Universal Antenna

In one implementation, a single layer MTM antenna structure can be used to form a universal antenna that operates in multiple frequency bands, e.g., frequencies from 700 MHz to 6000 MHz. FIGS. 5-11 illustrate an example of a single-layer MTM antenna and its operations in different frequency bands with a compact structure.

FIG. 5 shows antenna components of this single layer MTM universal antenna formed in one metallization layer on a substrate (e.g., an FR-4 substrate) for implementing the system in FIG. 4. The single metallization layer is patterned to form the antenna components can be formed of a suitable metal, such as copper, tin or silver. More specifically, the single-layer MTM antenna in FIG. 5 includes a conductive element as the electrical ground 570 of the antenna and an antenna structure with two structures 501 and 502 that are capacitively coupled to each other and separated by a gap 503. The two structures 501 and 502 together form the MTM antenna. The structure 502 is connected the to ground 570.

The first structure 501 forms a spiral design with an inner conductive line 505 and an outer conductive line 507 that surrounds the inner conductive line 505. The first cell structure 501 includes a first conductive patch 509 that interconnects the inner conductive line 505 and the outer conductive line 507. One end portion of the inner conductive line 505 is connected to the first conductive patch 509 which is connected to the outer conductive line 507. The first cell structure 501 includes a second conductive patch 511 to which the other end portion of the outer conductive line 507 is connected. The first and second conductive patches are separated by a gap 513 and are capacitively coupled via the gap 513. The second conductive patch 511 includes a first stub extension 515 and a second stub extension 517 and is separated from and capacitively coupled to the second structure via the gap 503.

The second structure 502 includes a first conductive patch 519 and a second conductive patch 521 which are joined together by a conductive meander line 523. The first conductive patch 519 interfaces with the second conductive patch 511 of the first cell structure 501 via the gap 503. The second conductive patch 521 is connected to the ground metallization structure 570 such as the LCD display ground or available metal around the laptop screen 105 in FIG. 1.

In operation, the single cable 405 or 407 in FIG. 4 is connected to an input/output port 550 to direct a transmission or reception signal between the MTM antenna and a respective diplexer in FIG. 4. For example, the single cable 405 or 407 can be connected to the location 550 on the second stub extension 517. In implementations, the shapes and dimensions of various parts of the structures 501 and 502 for antenna elements in the MTM antenna in FIG. 5 can be controlled to modify and tune the resonance frequencies.

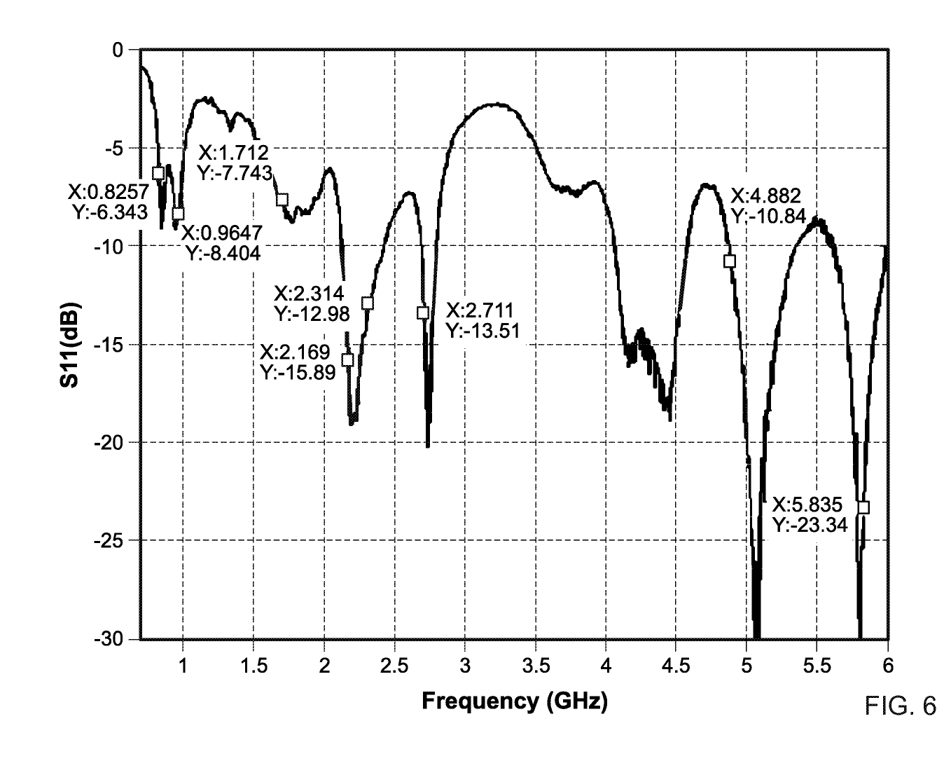

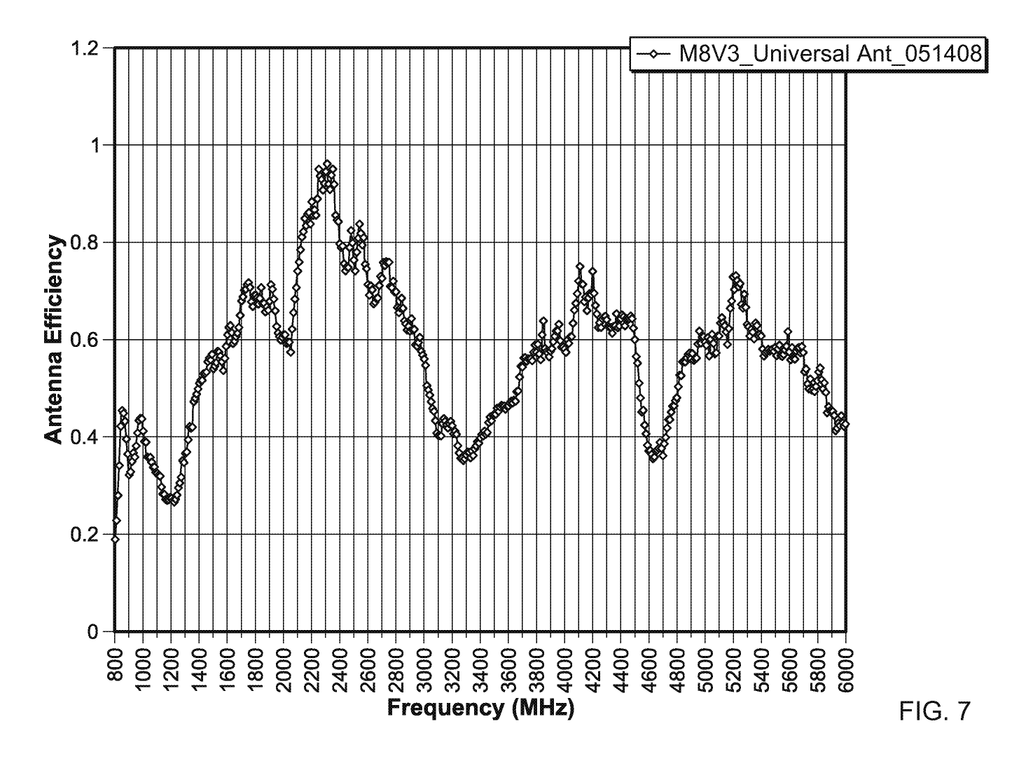

FIG. 6 and FIG. 7 show, respectively, measured return loss and efficiency with respect to the signal frequency of an MTM single layer universal antenna based on the design in FIG. 5. The measured results of FIG. 6 and FIG. 7 affirm simulated return loss and efficiency. Notably, the measured efficiency at the higher bands from 4.9 GHz to 5.7 GHz indicate an improvement of at least 10% over simulated measurements. Tuning and matching structural elements of the single layer universal antenna can be used to achieve low, mid, and high bands where different parts of the MTM antenna transmit or receive signals at different frequencies.

Low Band 824-960 MHz

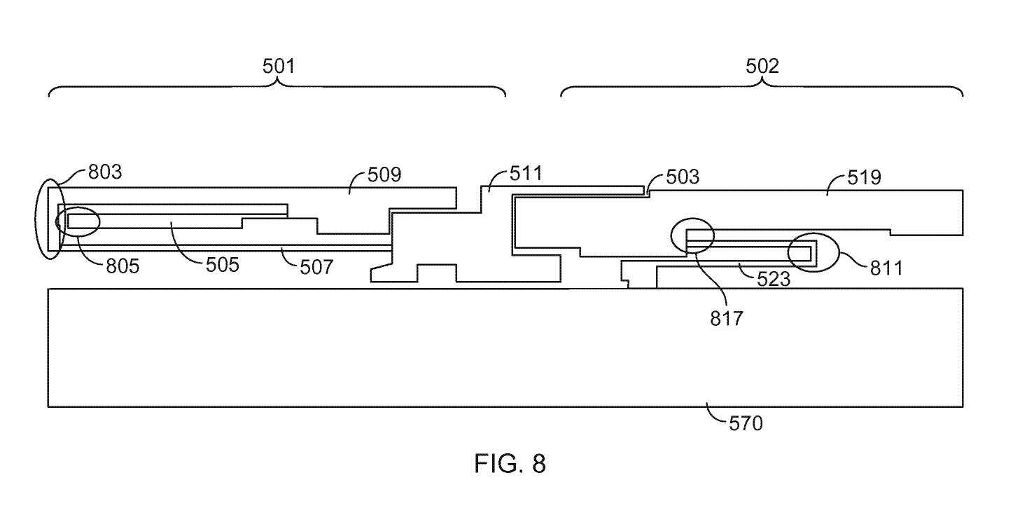

The low band of the antenna in FIG. 5 can range from 824 MHz to 960 MHz and is supported by specific structural elements shown in FIG. 8 of the MTM antenna in FIG. 5. Different spectral portions of the low band from 824 MHz to 960 MHz are affected by different parts of the MTM antenna. The lower resonance frequencies of the low band are transmitted and received by the spiral structure in the structure 501. The relative position of the distal part 805 of the inner conductive line 505 relative to the portion 803 of the outer conductive line 507 can affect the lower resonance frequencies of the low band and effectuate a slight affect on other antenna resonances. The antenna resonances may also be affected by changing the width and total length of the distal part 805 of the inner conductive line 505. Affected resonances may be shifted or slightly mismatched. The upper mid bands from 2.3 GHz to 2.7 GHz of the MTM antenna are also transmitted and received in the same region of the spiral structure of the structure 501. Structural changes for operations at the low band affect the frequencies in the upper mid bands from 2.3 GHz to 2.7 GHz.

The upper resonance frequencies of the low band can be controlled by the cell structure 519 and the conductive meander line 523. Wireless signals in this spectral range are transmitted or received by the areas 817 and 811. The area 811 of the conductive meander line 523 may be extended in or out relative to the conductive path 511 to tune the resonance around 925 MHz for the return loss while not significantly changing the area of the antenna. This resonance can be matched by the coupling between the cell patch 519 and the second conductive patch 511 through gaps 503 and by the connection 817 that connects the conductive meander line 523 to the cell patch 519. Matching the resonance of the MTM antenna to an input signal may be used to prevent the input signal from being reflected back to configure the total capacitance from the gaps 503 and the total inductance from the conductive meander line 523 so that they are matched to the input of 50 ohms, for example.

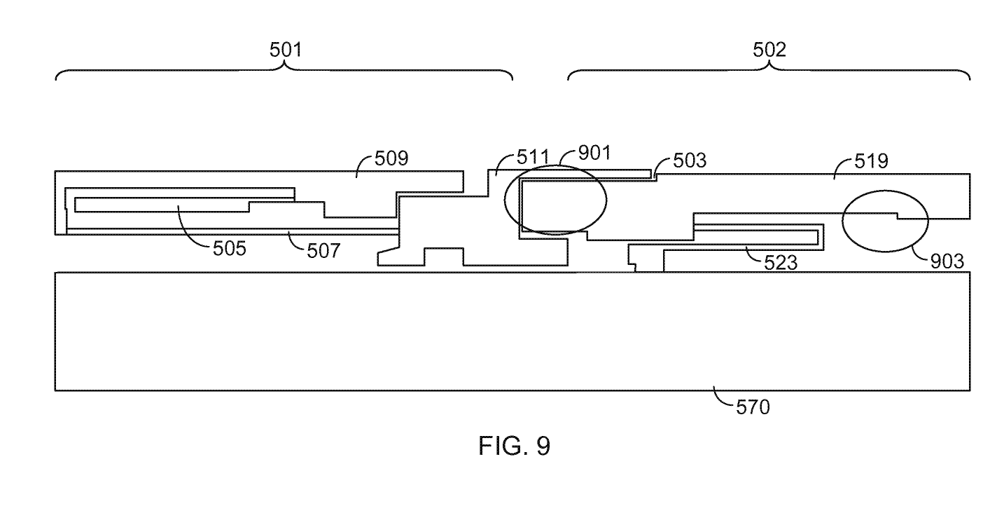

Lower Mid Band 1.710-2.170 GHz The MTM antenna also exhibits lower mid band resonances from 1.710 GHz to 2.170 GHz. FIG. 9 shows that the structures 901 and 903 of the single layer universal antenna in FIG. 5 that can significantly affect the frequencies of the antenna frequencies in the lower mid bands. The lower mid band resonances are controlled by the cell patch 519, the meander conductive line 523, and the loop portion 811 of the meander conductive line 523 via conductive line 811 as shown in FIG. 8. As shown in FIG. 9, tuning is accomplished by adding extra copper to the cell patch 519 near the structure 903, and the impedance matching is determined by the gaps 503 in the area 901 between the cell patch 519 and the conductive patch 511.

Upper Mid Bands 2.300-2.700 GHz

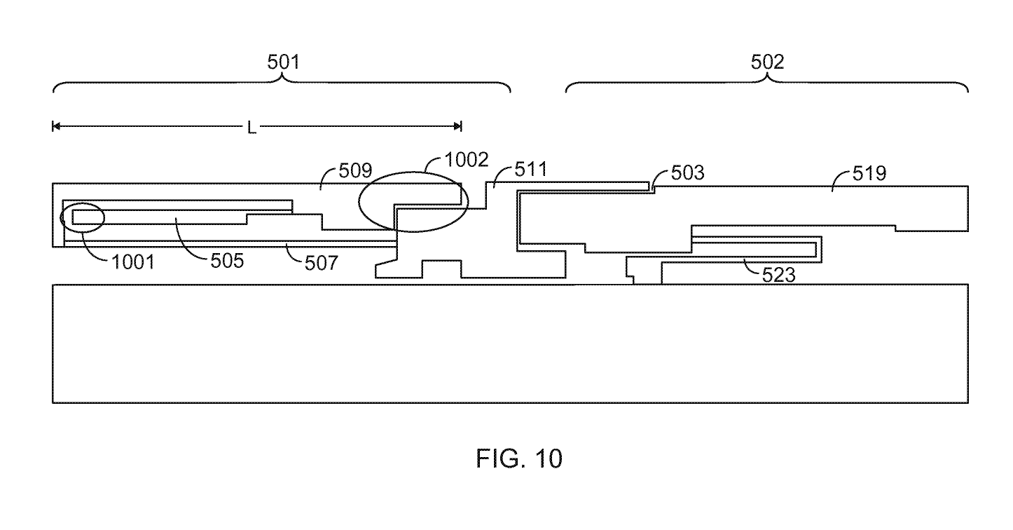

FIG. 10 illustrates specific structural elements 1001 and 1002 of the single layer universal antenna in FIG. 5 that can affect the antenna frequencies in the upper mid bands. The lower resonance frequencies in the upper mid band range are determined by the spiral structure in the structure 501. In particular, an increase in the thickness of the top line of the outer conductive line 507 in the spiral can reduce the resonance frequency in the upper mid band and a decrease in the thickness of the top line of the outer conductive line 507 in the spiral can increase the resonance frequency in the upper mid band. The impedance matching can be controlled by controlling the capacitive coupling between the conductive patch 509 and the patch 511 via the gap 513. An increase in the capacitance for the coupling via the gap 513 can improve the low band matching mode while also affecting the antenna resonance in the low band from 824 MHz to 960 MHz. The upper resonance frequencies in the upper mid band range are determined by the length L of the spiral in the structure 501. In particular, the size of the middle portion of spiral is adjusted and can have a larger affect to this range. For example, changing the length of spiral can shift the upper resonance mode at about 2.750 MHz and the low band. Changing the width of the spiral can shift the other resonance to about 2.3 GHz upper mid band resonance and have an effect on the high band relative to the lower band.

High Band 4.9-5.8 GHz

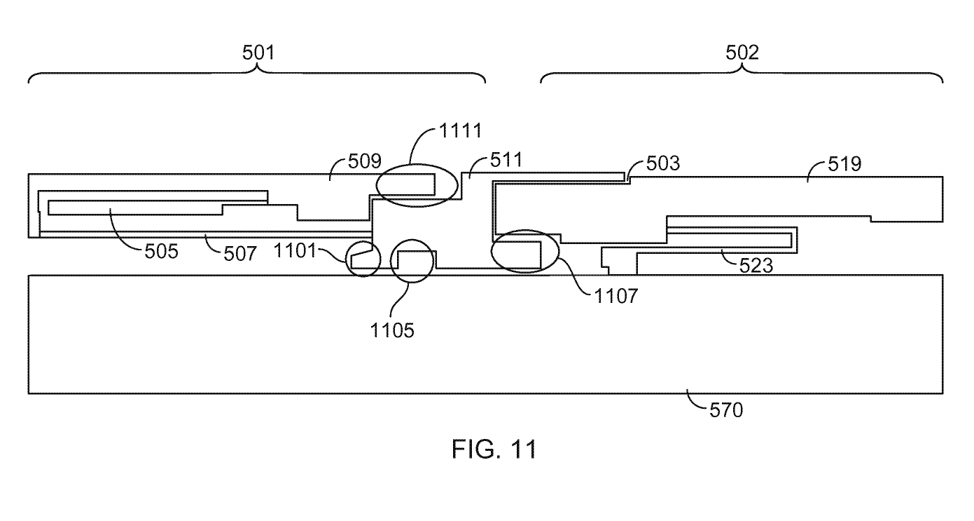

FIG. 11 illustrates specific structural elements 1101, 1105, 1107 and 1111 of the single layer universal antenna in FIG. 5 that can affect the antenna frequencies in the high bands from 4.9 GHz to 5.8 GHz. The impedance match in the high bands can be achieved by using the stub extension 515 that protrudes beneath the spiral in the structure 501 and by removing a bottom middle portion of the patch 511 to form a notch 1105 between the stub extensions 515 and 517. An additional high band resonance can be generated by extending the stub extension 517 under the cell 519. Such high frequency bands have wider antenna bandwidths in comparison to bands at lower frequencies. In implementations, the highest resonance for this antenna can be tuned to a frequency that is higher than needed to increase the associated antenna bandwidth.

Multi Layer Universal Antenna

The universal antenna design in FIG. 4 can also be implemented by a multi layer antenna structure that is constructed to support multiple frequency bands in a broad range of frequencies such as from 700 MHz to 6000 MHz.

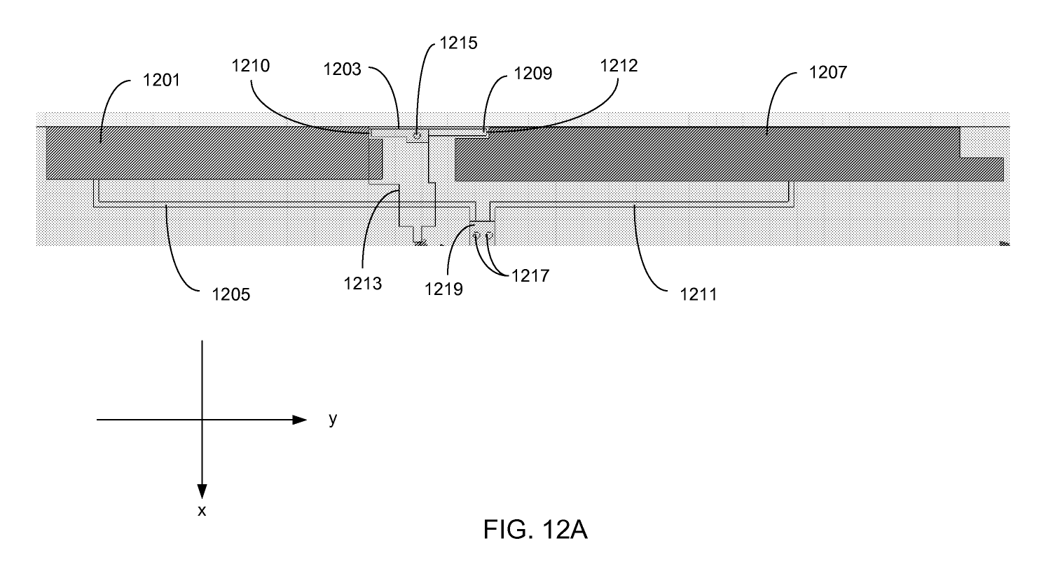

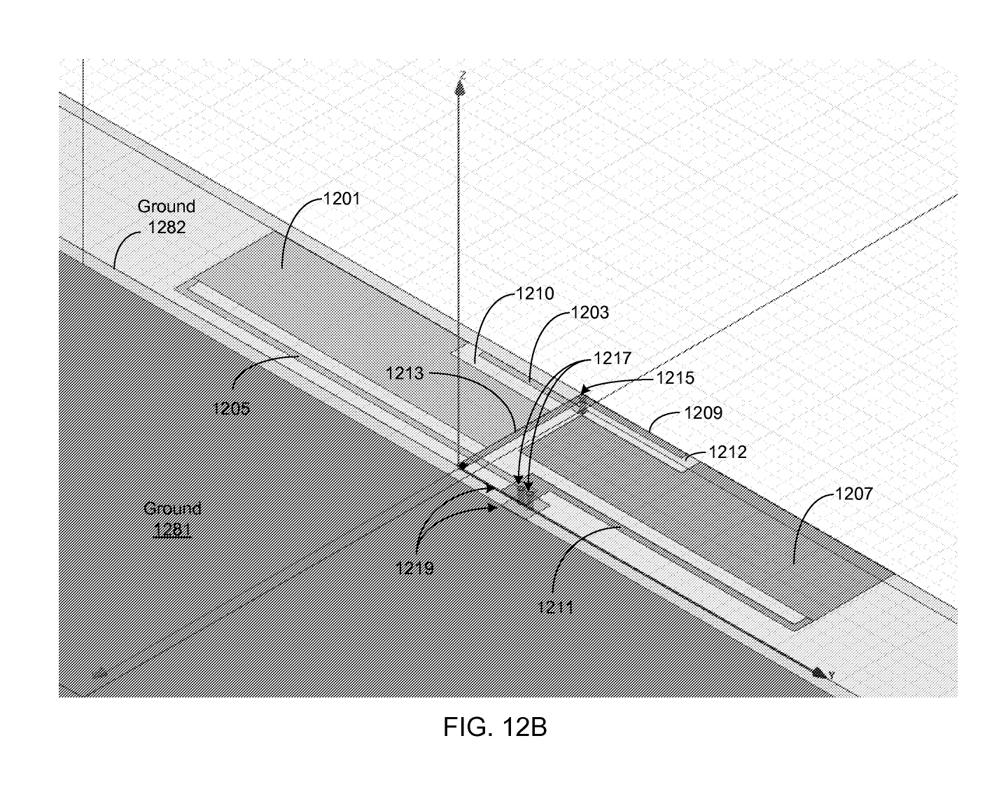

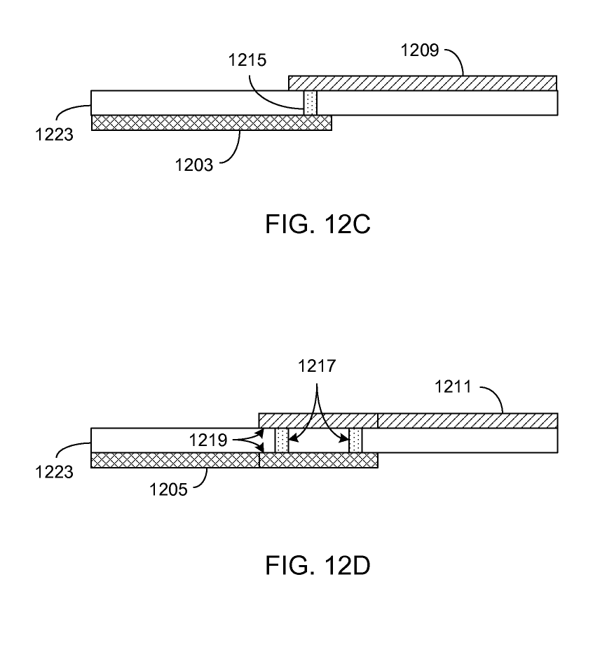

FIGS. 12A-12D show one example of a multi-layer MTM universal antenna formed in a substrate (e.g., an FR-4 substrate). In this example, the antenna elements are formed in two metallization layers on two surfaces of the substrate. The first metallization layer is formed on a first side of the substrate and is patterned to include first metamaterial antenna elements. The second metallization layer is formed on a second side of the substrate opposing the first side and is patterned to include second metamaterial antenna elements. A conductive via is formed in the substrate to connect one of the first metamaterial antenna elements to one of the second metamaterial antenna elements. The first and second metamaterial antenna elements collectively to provide antenna operations at different frequency bands.

As shown in FIGS. 12A and 12B, the universal antenna in this example includes a first cell patch 1201, a first launch pad 1203, and a first via line 1205, all formed on a first metallization layer. In some implementations, the dimensions of the first cell patch 1201, the first launch pad 1203, and the first via line 1205 may be about 25×4.5 mm, 5×0.3 mm, 30×0.3 mm (including all bends from patches 1219 to the cell 1201), respectively. As shown in FIGS. 12A and 12B, the multi layer antenna includes a second cell patch 1207, a second launch pad 1209, a second via line 1211, and a feed line 1213, all formed on a second layer. In some implementations, the dimensions of the second cell patch 1207, the second launch pad 1209, the second via line 1211, and the feed line 1213 may be about 35×4.5 mm, 7×0.3 mm, 30×0.3 mm (including all bends from patches 1219 to the cell 1207), respectively. Each cell patch (1201 or 1207) and its respective launch pad (1203 or 1209) are separated from each other by a gap and are capacitively coupled to each other for transmission of signals. Each via line (1205 or 1211) is connected to its respective cell patch (1201 or 1207).

As shown in FIGS. 12A, 12B and 12C, a conductive via 1215 is formed in the substrate 1223 to provide a conductive path between the first launch pad 1203 on the first layer and the second launch pad 1209 on the second layer. As shown in FIGS. 12A, 12B and 12D, two vias 1217 are also formed in the substrate 1223 and are connected to two conductive patches 1219 on the first and second layers, respectively, providing a conductive path between the first via line 1205 on the first layer and the second via line 1211 on the second layer. In some implementations, the dimensions of the vias (1215, 1217) may be about 0.5 mm in diameter.

Referring to FIG. 12B, the antenna includes a first ground 1280 formed in the first layer at a location that is displaced from the first cell patch 1201 and the footprint of the second cell patch 1207 on the first layer and a second ground 1280 formed in the second layer at a location that is displaced from the second cell patch 1207 and the footprint of the first cell patch 1201 on the first layer. The first ground 1281 connects to the conductive patch 1219 in the first layer and the second ground 1281 connects to the conductive patch 1219 in the second layer.

The MTM antenna in FIGS. 12A-12D, when used to implement the antennas 401 and 403 in the system in FIG. 4, is connected to the single cable 405 or 407 for transmitting signals to or receiving signals from two or more PCI cards 413 and 414. Referring to FIGS. 12A and 12B, the single cable 405 or 407 can be coupled to either one of the first launch pad 1203 and the second launch pad 1209 to direct signals from the PCI cards 413 and 414 to the MTM antenna or to receive signals from the MTM antenna. Examples of tuning and matching structural elements of the multi layer universal antenna in FIGS. 12A-12D to achieve low, mid, and high bands are provided below.

Low Bands 824 MHz-960 MHz

The lower end of the low band from 824 MHz to 960 MHz is controlled by the second cell structure 1207, the second via line 1211, and the first launch pad 1203. The upper end of the low band is controlled by the first cell patch 1201, the first via line 1205, the first launch pad 1203, the feed line 1213, and second launch pad 1209.

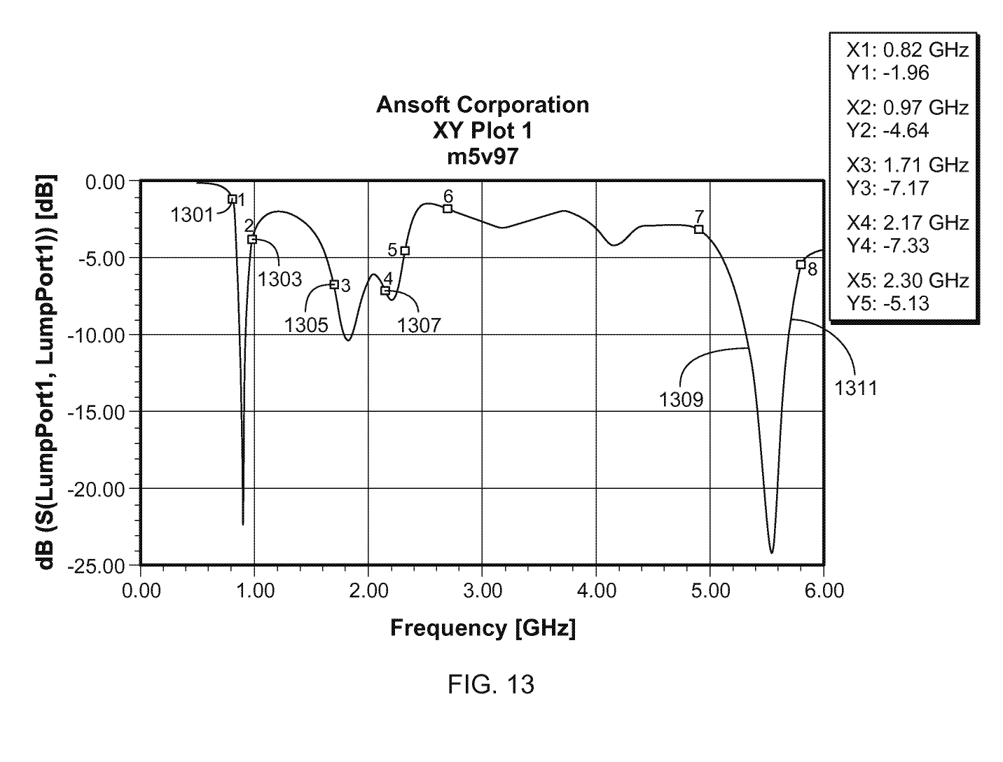

FIG. 13 illustrates approximate locations of the lower end 1301 and the upper end 1303 of the low band.

The lower end 1301 of the low band is tuned by increasing or decreasing the amount of the surface area on the first cell patch 1201. This can be achieved by elongating the cell patch 1201 or 1207 in the y direction in FIG. 12A towards the edge of the board, or by extending the first cell patch 1201 in the x direction towards a ground electrode where the ground 1280 connects with the edge of patches 1219 and is attached to the upper edge of the device layout. In this example, the upper edge of the device layout is inside the top edge casing of the laptop display 105 shown in FIG. 1.

Tuning the upper end 1303 of the low band can be achieve by tuning the second cell patch 1207 by increasing or decreasing the amount of the surface area. By modifying the second cell patch 1207, other harmonics are minimally affected by changes in the second cell patch 1207 in terms of matching and frequency changes.

The first via line 1205 and second via line 1211 are connected at the same point from the ground. In FIG. 12D, conductive patches 1219 are defined on the first and the second layers, and vias 1217 are used to connect these layers. This connection is beneficial to matching the harmonics of the lower end 1301 and the upper end 1303 of the low band. Through simulations, when both via lines 1205 and 1211 are not joined together, a mismatch can occur and a null can exist between lower end 1301 and the upper end 1303 of the low band. A null may exist between the lower end 1301 and the upper end 1303 of the low band and can prevent the two ends from merging which may help widen the bandwidth. Varying the lengths of the via lines 1205 and 1211 are considered for changing the location of the lower end 1301 and the upper end 1303 of the low band. Since both via lines 1205 and 1211 are connected together, the length and width of the first via line 1205 and the second via line 1211 proportionally can have an effect on the responses of both the lower end 1301 and the upper end 1303 of the low band.

Coupling between the feed line 1213 on the first layer and the first cell structure 1201 on the second layer also can have an effect on the upper end harmonic 1303 of the low band. More overlap can result in a down shift in frequency for the harmonic 1303, but can also result in a down shift in frequency for harmonics 1309 and 1311.

Mid Bands 1.71-2.40 GHz

The mid bands from 1.71 GHz to 2.40 GHz have an lower end 1305 and an upper end 1307 as shown in FIG. 13. The lower end 1305 of the mid band is controlled by the second cell structure 1207, the second via line 1211, and the first launch pad 1203. The upper end 1307 of the mid band is controlled by the first cell structure 1201, the first via line 1205, the first launch pad 1203, the feed line 1213, and second launch pad 1209.

The lower end 1305 and the upper end 1307 of the mid band are controlled by both the first launch pad 1203 and the second launch pad 1209. The associated parameters include a gap 1210 between the first cell structure 1201 and the first launch pad 1203, a gap 1212 between the second cell structure 1207 and the second launch pad 1209, the length and width of the launch pads 1203 and 1209, and the via 1217 that connects the second launch pad 1209 to the feed line 1213. Gaps 1210 and 1212 can play a role in matching the two harmonics, while the length and width of the launch pads can shift the harmonics frequency location.

High Bands 4.80-5.40 GHz

FIG. 13 illustrates approximate locations of the lower end 1309 and the upper end 1311 of the high band from 4.80 GHz to 5.40 GHz. The lower end of the high band is controlled by the second cell structure 1207, the second via line 1211, and the first launch pad 1203. The upper end of the high band is controlled by the first cell structure 1201, the first via line 1205, the first launch pad 1203, the feed line 1213, and the second launch pad 1209.

The lower end 1309 and the upper end 1311 of the high band are controlled by the feed line 1213 by adding copper patches towards the top or bottom end of the feed line 1213 thereby increasing its thickness. The amount of copper that is present can also have a large affect on the higher harmonics. Changing the feed line 1213 can also affect the upper end 1203 harmonic of the low band as previously described herein.

Tuning Methods Across the Low, Mid, and High Bands

Various components can be configured in designing the MTM antenna in FIGS. 12A-C to tune the antenna frequency across the low, mid, and high bands. Some tuning examples are now provided below.

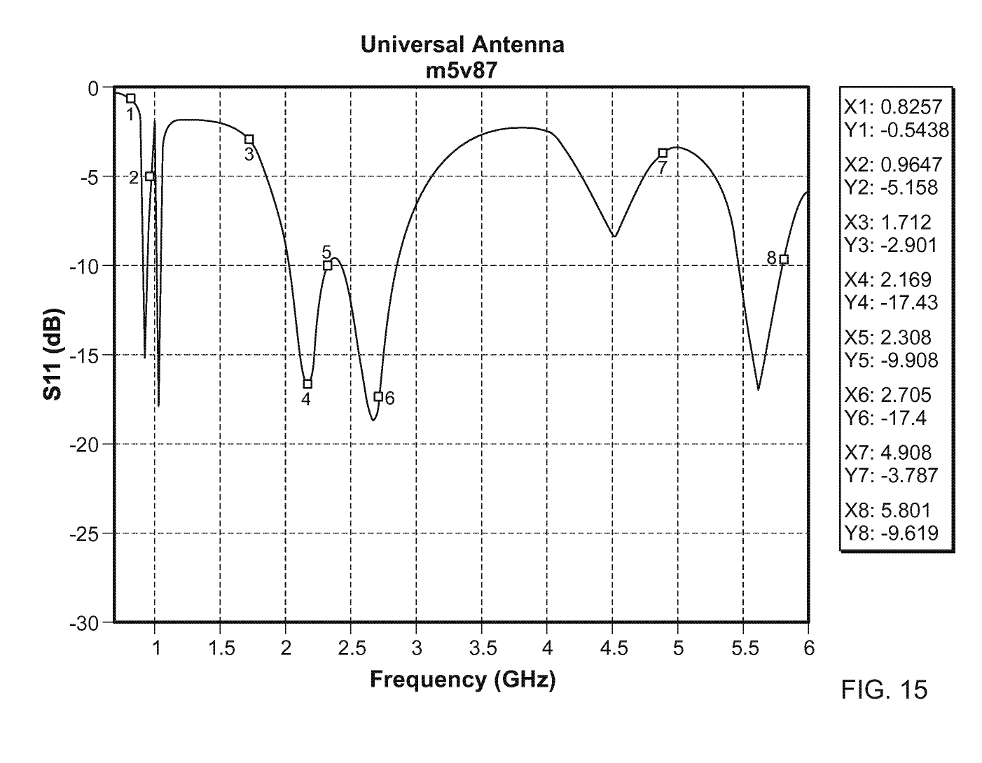

Adding a patch of copper at the end of the first cell structure 1201, as shown in FIG. 12A, can have an effect of lowering the frequency of the lower end 1301 of the low band. However, matching may degrade at the lower end 1301 of the low band. This is illustrated in FIG. 15 by the null that exists between the lower end 1301 and the upper end 1303 of the low band which may no longer resemble the same impedance or 50 ohm match as the upper end 1303 resonance.

The capacitance can increase for the lower end 1301 harmonic by decreasing the gap 1210 between the first launch pad 1203 and the first cell structure 1201, and/or by adding more copper from the feed line 1213 such that the feed line 1213 lies directly above the first cell structure 1201. Adding more copper, however, can affect the higher bands and mid bands since the launch pads are attached to the feed line 1213. The capacitance may also increase for the lower end 1301 harmonic by extending the length of the first launch pad 1203 so that more area of the first launch pad 1203 can couple with the first cell structure 1201. This extension of the first launch pad 1203 may reduce the lower end 1305 of the mid band in frequency.

Shortening the second via line 1211 and changing location of the second via line 1211 and the second cell structure 1207 connection can affect the lower end 1301 and the upper end 1303 of the low band. By shortening the second via line 1211, the upper end 1303 of the low band can shift up in frequency, splitting the lower end 1301 and the upper end 1303 apart. However, the lower end 1301 may shift up as well, but not by the same degree as the upper end 1303. The connection can change from the second cell structure 1207 and the second launch pad 1209, and the impedance may change and become unmatched to 50 ohm. This may have the same effect as adding a copper patch at the end of first cell structure 1201 thereby reducing the resonance in frequency. Compensation steps are considered, as stated above, for adding a patch at the end of the first cell structure 1201.

Adding more copper to the second launch pad 1209 to the space provided between the feed line 1213 and cell 1207 can have an effect of reducing the frequency of the upper end 1307 of the mid band without changing the capacitance to the second cell structure 1207 and without causing impedance mismatch for the harmonic of the upper end 1303 of the low band. This modification can affect the upper end 1311 of the high band since the launch pad 1209 is part of the feed line 1213 and may reduce the upper end 1311 of the high band in frequency.

Adding copper to the feed line 1213 may increase the lower end 1309 and the upper end 1311 of the high band. In addition, adding copper in various locations can change the higher mode locations.

Diplexer:

Referring to the system in FIG. 4, the single left cable 405 is connected to the left diplexer 409, and the single right cable 407 is connected to the right diplexer 411. The diplexers 409 and 411 are connected to the WLAN mini PC 413 and WWAN mini PC 415 and may be implemented in various configurations.

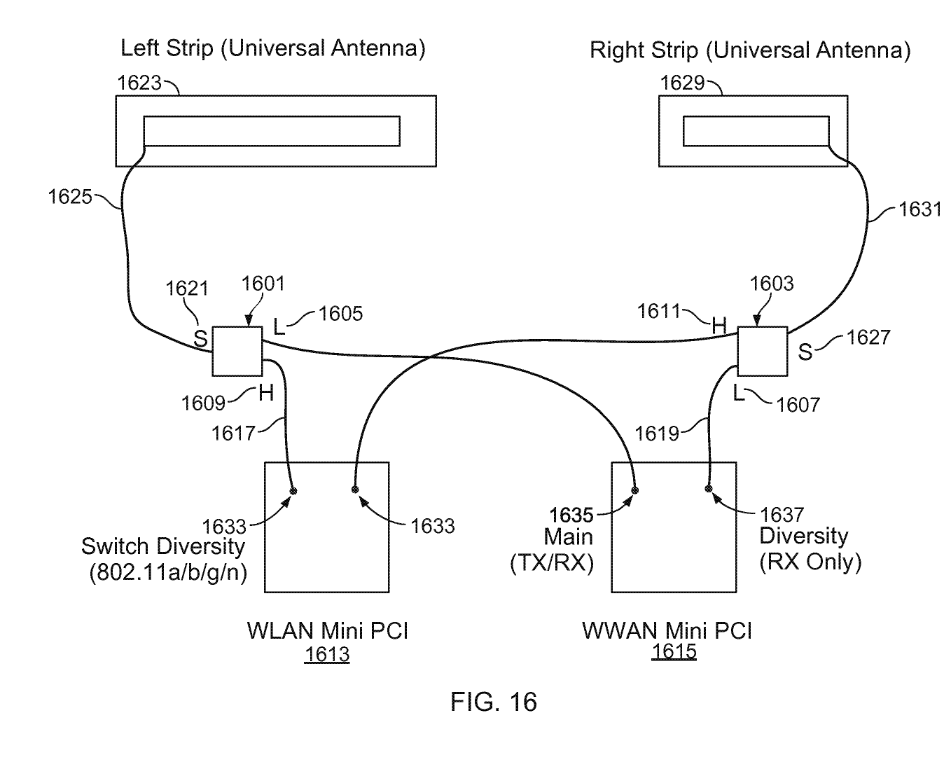

FIG. 16 shows an exemplary diplexer design for a passive, reciprocal device used for frequency domain multiplexing from two ports (L and H) onto one port (S) and vice versa in a device with WLAN and WWAN PCI cards based on the design in FIG. 4. In this example, the left port L 1605 and right port L 1607 are each associated with the low frequency range (WWAN) PCI card 1615, and left port H 1609 and right port H 1611 are associated with the high frequency range (WLAN) PCI card 1613. The diplexer 1601 or 1603 can include a low-pass filter between ports L and S and a high-pass filter between ports H and S. Port H and the WLAN mini PCI 1613 are connected via a short cable 1617, and port L and the WWAN mini PCI are connected via another short cable 1619. The left single port S 1621 is coupled to the left strip universal antennal 1623 via cable 1625, and the right single port S 1627 is coupled to the left strip universal antennal 1629 via cable 1631. Switch diversity 1633, TX/RX 1635, and RX 1637 are the same components described hereinabove and in FIG. 2. The isolation target between these two short cables (or between ports L and H) can be the same as the antenna isolation target listed in the table in FIG. 3.

Other diplexer designs based on MTM structures that may be used for implementing the Universal-Antenna Single-Cable Configuration system shown in FIG. 4 are described in U.S. patent application Ser. No. 12/272,781 entitled “Filter Design Methods and Filters Based on Metamaterial Structures,” filed on Nov. 17, 2008, which is hereby incorporated by reference as part of the disclosure of this document.

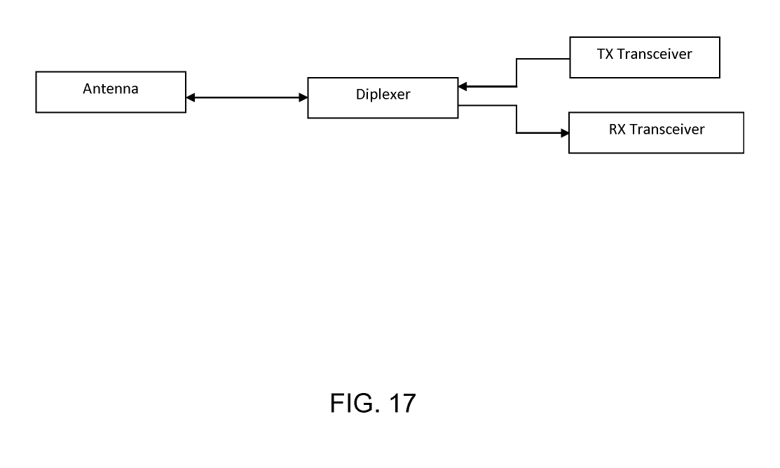

In one exemplary diplexer design, the diplexer receives an input signal from a TX transceiver and transmits the signal to an antenna for transmission as illustrated in FIG. 17. The same diplexer can also receive a signal from the antenna and transmit the received signal to an RX transceiver. The diplexer design can be used for cell-phone Band VIII (RX: 880-915 MHz & TX: 925-960 MHz) and Band III (RX: 1710-1785 MHz & TX: 1850-1880 MHz) in various implementations. For example, for a first implementation (Implementation A), a Band III transmit signal (TX: 1850-1880 MHz) can be sent to the antenna while a Band VIII receive signal (RX: 880-915 MHz) can be sent to the RX transceiver. In another implementation (Implementation B), a Band VIII transmit signal (TX: 925-960 MHz) can be sent to the antenna while a Band IIII received signal (RX: 1710-1785 MHz) can be sent to the RX transceiver.

The diplexer can be also designed to reject harmonics of the transmit frequencies. For example, the diplexer's low-band portion near 900 MHz has at least a −40 dB rejection at the high-band near 1800 MHz. Furthermore, the higher harmonics (i.e., greater than 3 GHz) of the TX high-band near 1800 MHz can be suppressed by the diplexer. The diplexer may be configured to maintain at least a −27 dB isolation between the low and high band of the diplexer.

Other diplexers with other frequency bands and band rejection/isolation requirements can be designed using the same methods described in this section.

Low-Pass (LP) Band-Pass (BP) Filter Design:

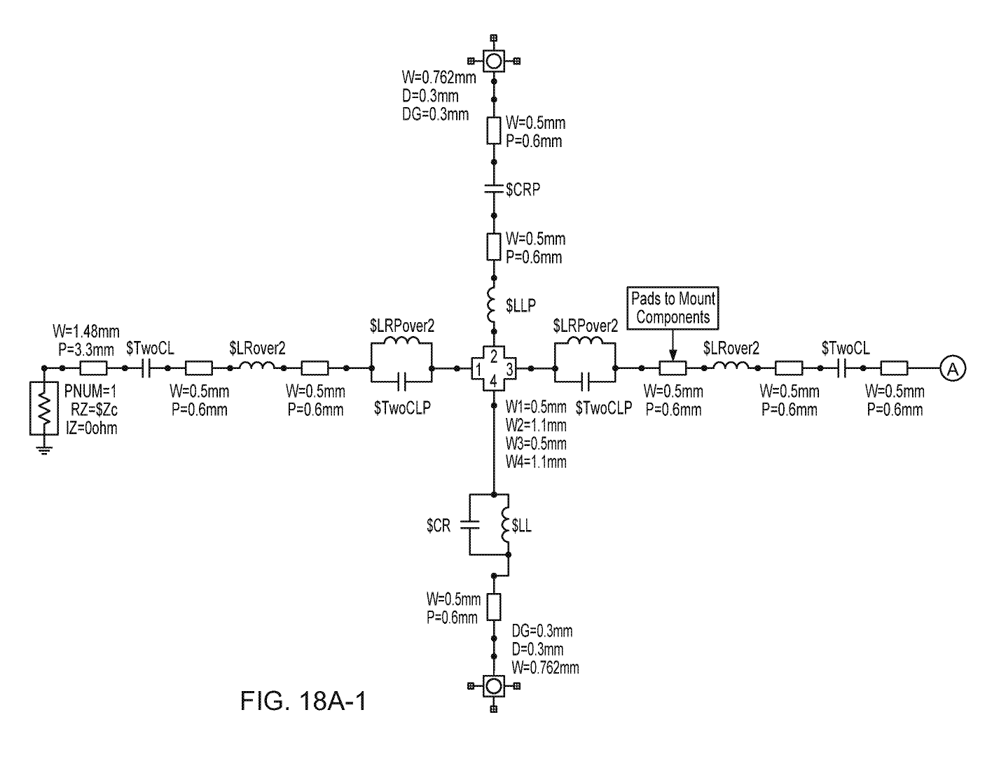

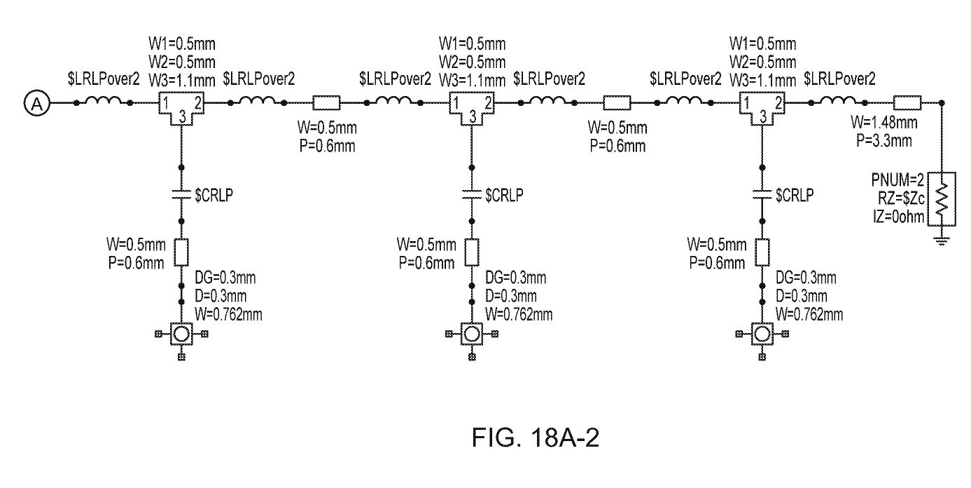

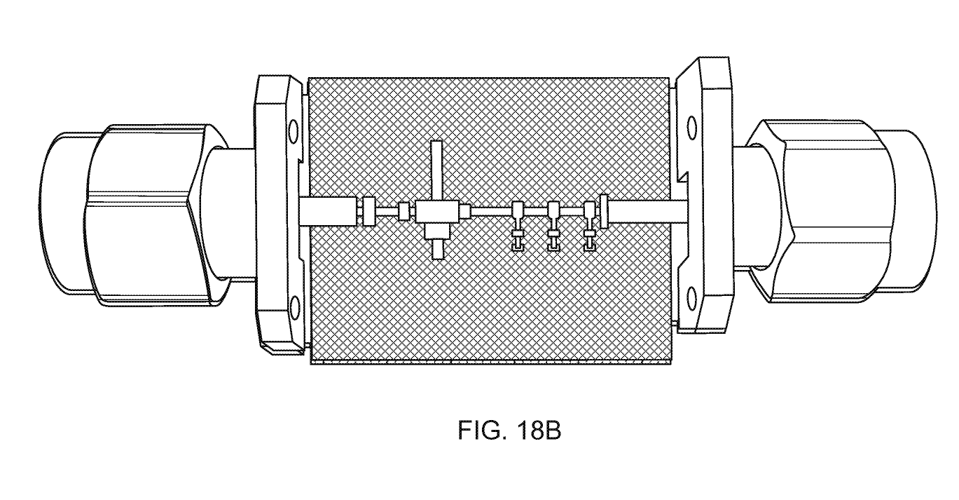

A low-band band-pass filter can be designed using one E-CRLH unit cell followed by a 3-cell conventional LP filter as depicted in FIG. 18A. In this design, pads are included in the design for stability and mounting purposes. The fabricated filter is illustrated in FIG. 18B.

The low-band portion of the cell-phone diplexer can be designed by setting the following parameters in the Matlab code as shown in Table 1.

TABLE 1

| | | | | | |
|---|---|---|---|---|---|
| Freq0_1 | 0.8 | GHz | Freq0_3 | 0.8 | GHz |
| Freq0_2 | 3.5 | GHz | Freq0_4 | 3.5 | GHz |
| LR | 6 | nH | LL | 5.87714 | nH |
| CR | 1.75 | pF | CL | 1.328893 | pF |
| LR′ | 17.63142027 | nH | LL′ | 2 | nH |
| CR′ | 3.986679062 | pF | CL′ | 0.583333 | pF |
| Need = 0 | 0 | 0 | 0 | | |

The circuit parameters, shown in Table 2, are used in the circuit simulation tool to evaluate the filter response.

TABLE 2

| Parameter | Value | Units | Value | |
|---|---|---|---|---|
| $Zc | 50 | ohm | 50 | ohm |
| $LRover2 | 6/2 | nH | 3 | nH |
| $CR | 1.75 | pF | 1.75 | pF |
| $LRPover2 | 17.5/2 | nH | 8.75 | nH |
| $CRP | 4 | pF | 4 | pF |
| $LL | 6 | nH | 6 | nH |
| $TwoCL | 2*1.3 | pF | 2.6 | pF |
| $LLP | 2 | nH | 2 | nH |
| $TwoCLP | 2*0.6 | pF | 1.2 | pF |
| $LRLPover2 | 13 nH/2 | | 6.5 | nH |
| $CRLP | 5 | pF | 5 | pF |

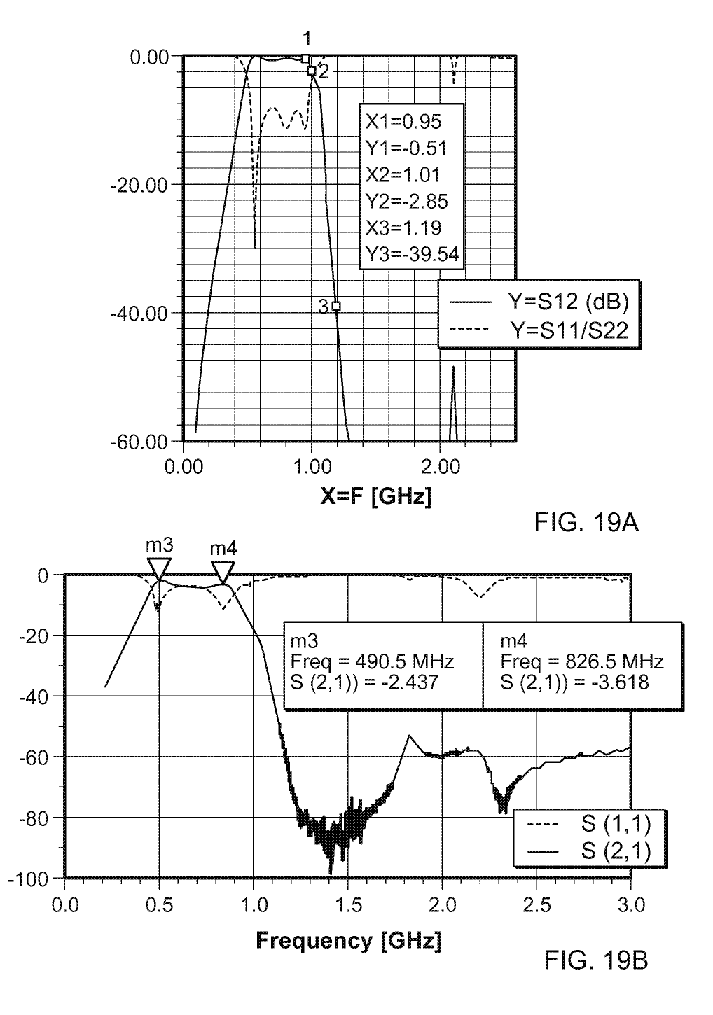

The simulated results are presented in FIG. 19A. The LP BP filter response complies with the diplexer lower-band spec in terms of covering 880-960 MHz band while rejecting higher harmonics and having a steep rejection above 1.1 GHz. Measured results shown in FIG. 19B confirms simulated results even with the higher measured insertion loss, which may be due to a low-quality lossy inductor and the capacitor selection.

High-Pass Band-Pass Filter Design:

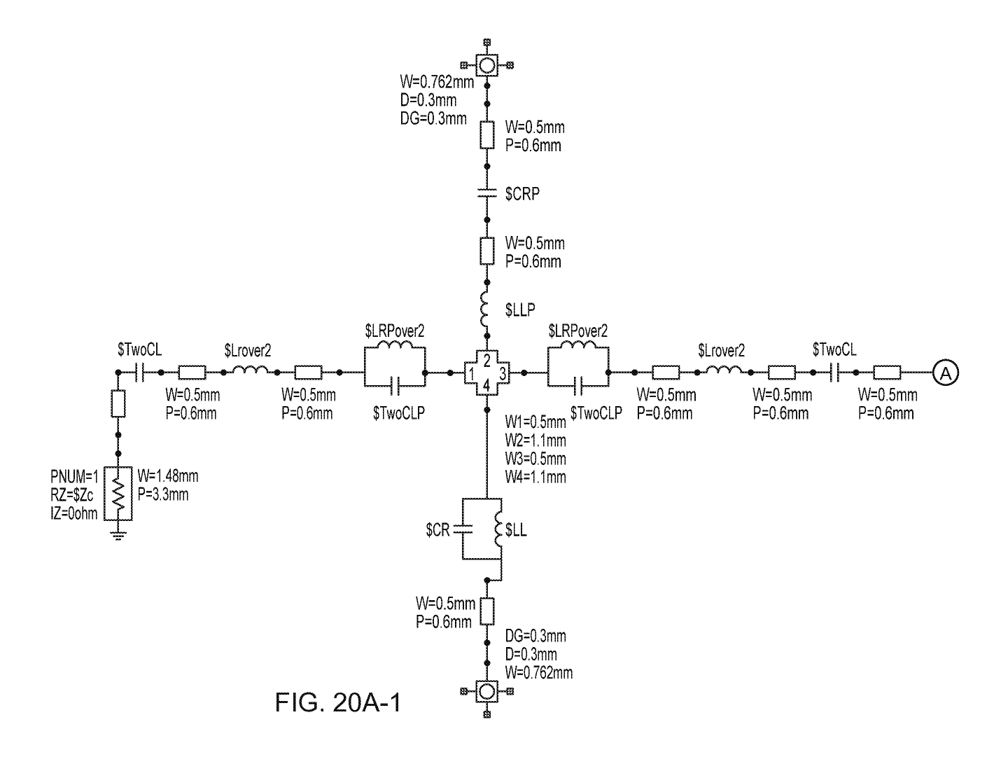

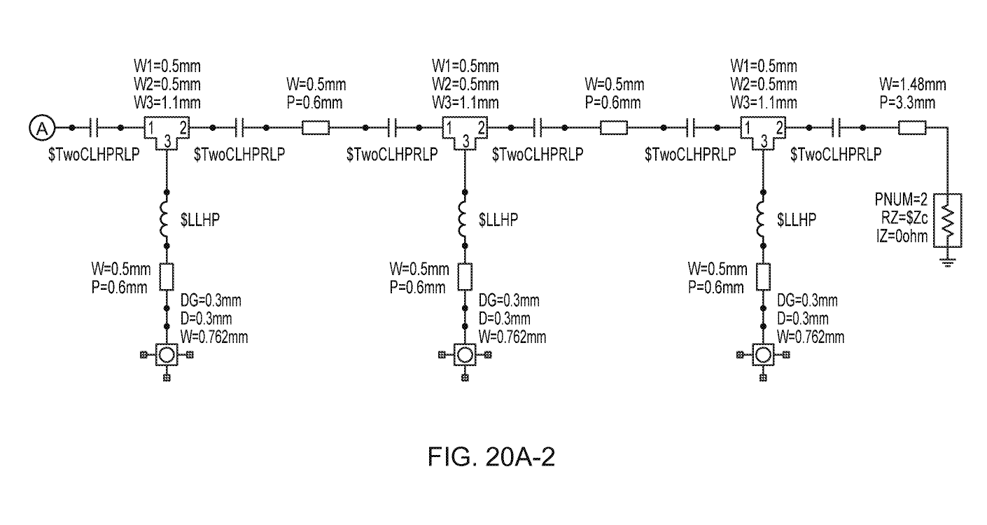

A high-band band-pass filter is designed using one extended CRLH (E-CRLH) unit cell followed by 3-cell conventional HP filter as depicted in FIG. 20. Pads can be included in the design to evaluate their effect of overall filter response.

The high-band portion of the cell-phone diplexer is designed by setting the following parameters in the Matlab code as shown in Table 3.

TABLE 3

| | | | | | |
|---|---|---|---|---|---|
| Freq0_1 | 0.6 | GHz | Freq0_3 | 0.6 | GHz |
| Freq0_2 | 2.1 | GHz | Freq0_4 | 2.1 | GHz |
| LR | 22 | nH | LL | 5.590318 | nH |
| CR | 3.9 | pF | CL | 0.844299 | pF |
| LR′ | 42.40930957 | nH | LL′ | 2.9 | nH |
| CR′ | 6.405030626 | pF | CL′ | 0.514091 | pF |
| Need = 0 | 0 | 0 | 0 | | |
| Zc | 75.10676162 | Ohm | | | |

The circuit parameters, shown in Table 4, are used in the circuit simulation tool to evaluate the filter response. Note, to account for the pads effects, the value of LR had to be increased from 22 nH to LR=30 nH, which was derived from the Matlab and the spreadsheet simulations.

TABLE 4

| Parameter | Value | Units | Value | |
|---|---|---|---|---|
| $Zc | 50 | ohm | 50 | ohm |
| $LRover2 | 30/2 | nH | 15 | nH |
| $CR | 3.9 | pF | 3.9 | pF |
| $LRPover2 | 42.4/2 | nH | 21.2 | nH |
| $CRP | 6.4 | pF | 6.4 | pF |
| $LL | 5.6 | nH | 5.6 | nH |
| $TwoCL | 2*0.85 | pF | 1.7 | pF |
| $LLP | 2.9 | nH | 2.9 | nH |
| $TwoCLP | 2*0.51 | pF | 1.02 | pF |
| $LLHP | 3.3 | nH | 3.3 | nH |
| $TwoCLHP | 2*1.3 | pF | 2.6 | pF |

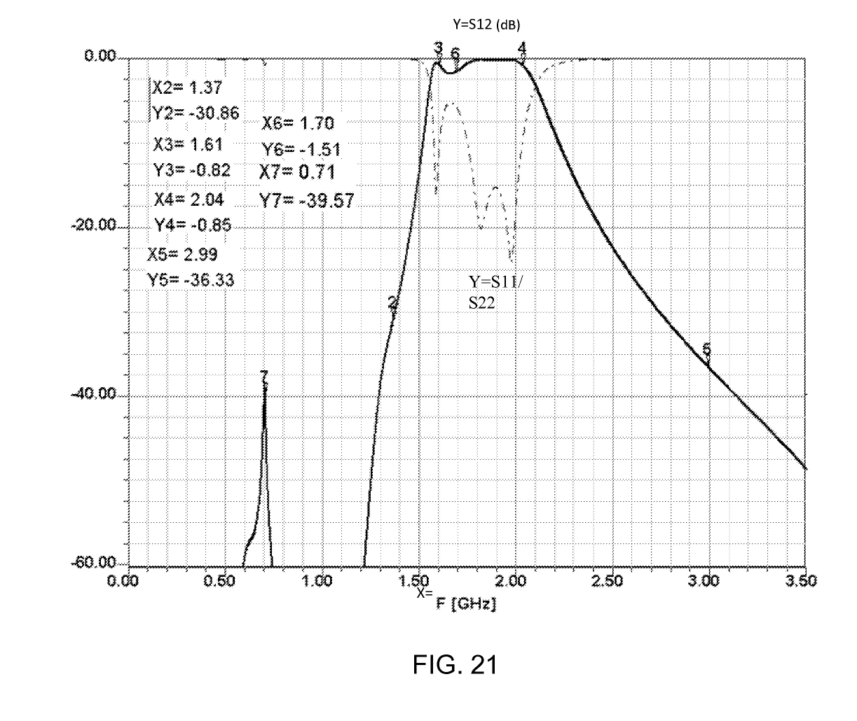

The simulated results are presented in FIG. 21. From FIG. 21, the HP BP filter response complies with the diplexer upper-band spec in terms of covering 1710-1880 MHz band while rejecting higher harmonics (greater than 3 GHz) and having a steep rejection below 1.37 GHz.

Complete Diplexer Assembly:

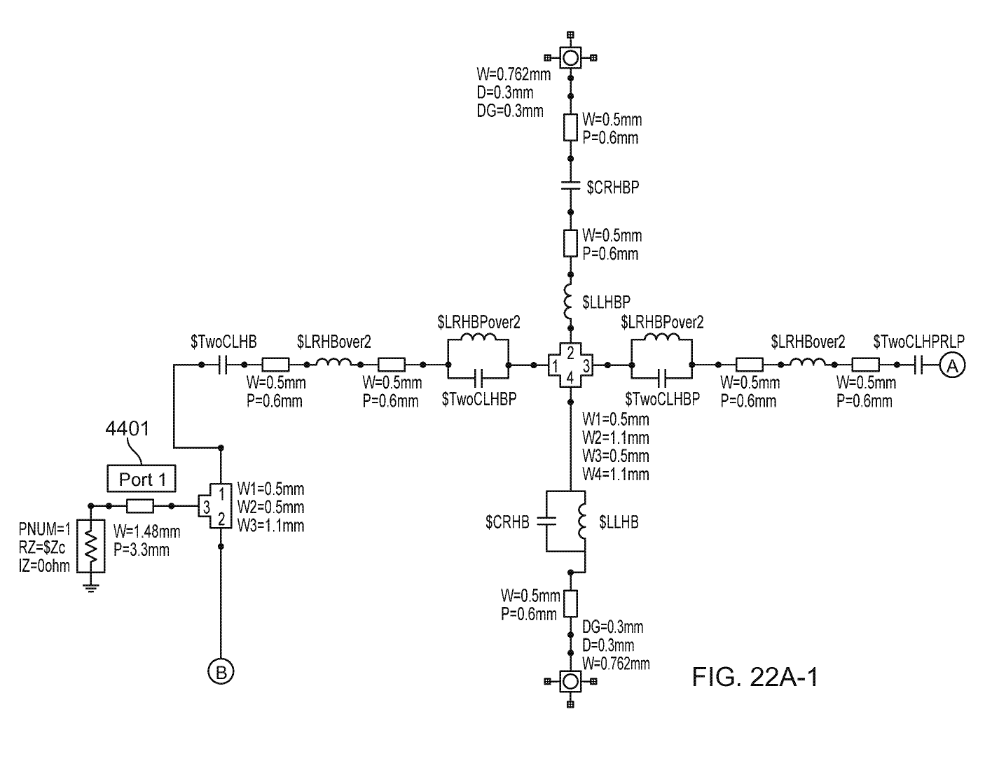

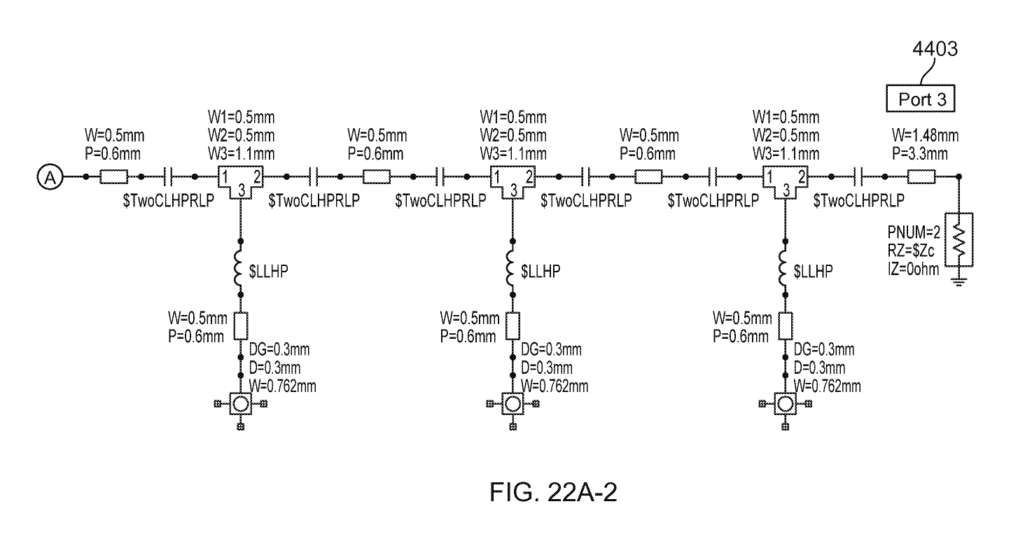

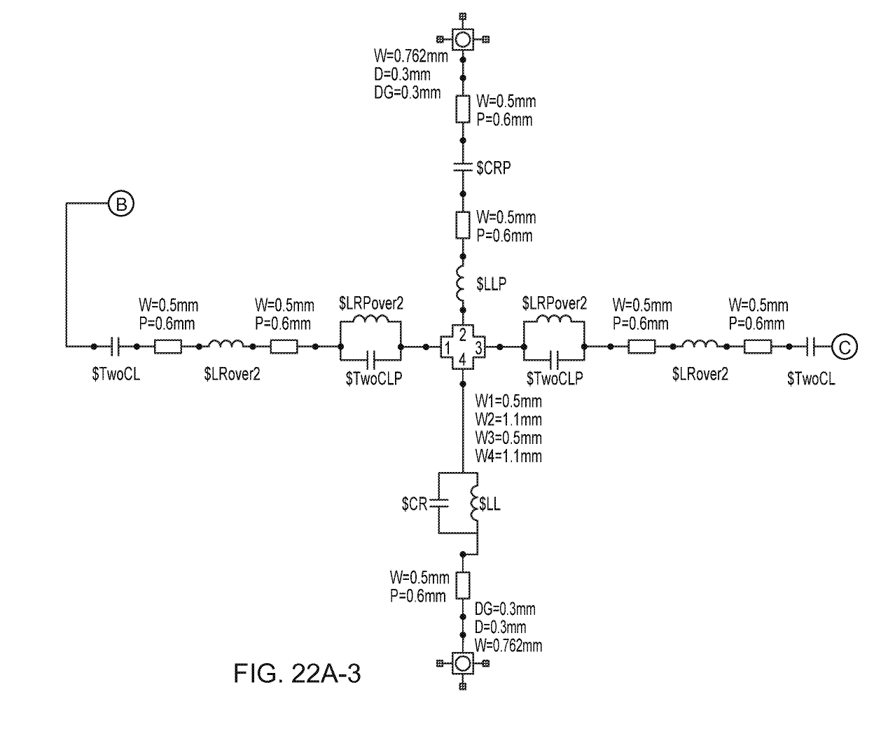

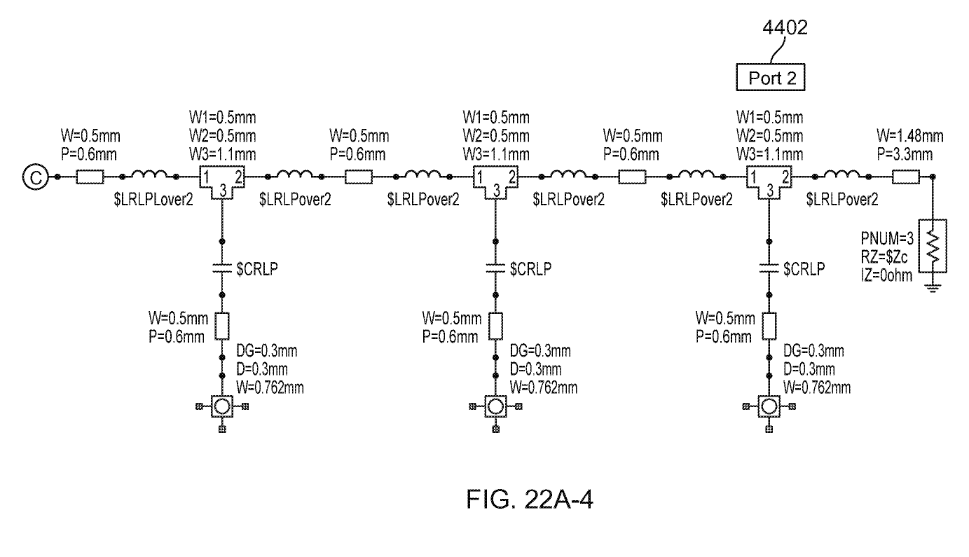

The complete diplexer circuit assembly is shown in FIG. 22 and depicts three ports:

Port 1 4401: antenna input/output port.

Port 2 4402: antenna to low-band Rx transceivers or from low-band TX transceiver.

Port 3 4403: antenna to high-band Rx transceivers or from high-band TX transceiver.

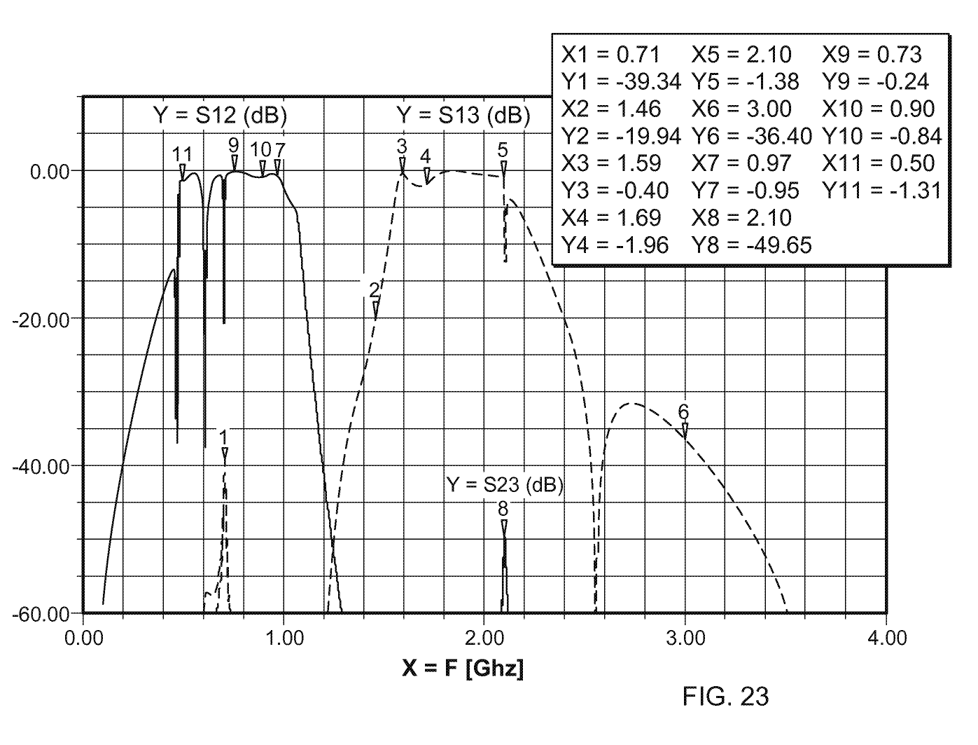

The diplexer response is illustrated in FIG. 23. From simulation data, the higher-harmonics rejection is below −40 dB, and the isolation between the lower and upper band is maintained below −40 dB. Furthermore, the isolation between transceiver ports 2 and 3 is maintained below −40 dB.

A wireless communication system in a universal-antenna single-cable configuration with three PCIs:

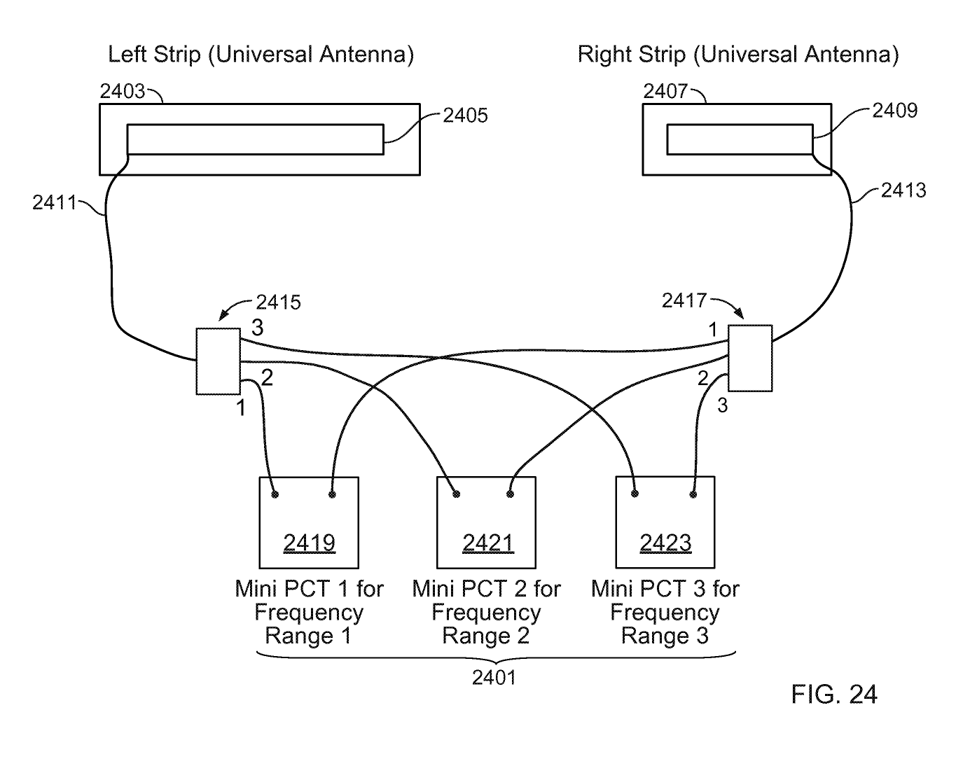

FIG. 24 shows an exemplary system with three mini PCIs 1701 operating at three different RF frequency ranges. In this example, a left strip 2403 is provided to include a universal antenna 2405 and a right strip 2407 is provided to include a universal antenna 2409. The left universal antenna 2405 and right universal antenna 2409 are designed and operated for an entire frequency range covering three different frequency ranges and are connected to a left single cable 2411 and a right single cable 2413, respectively. The other end of the left and right cables 2411 and 2413 are connected to a left and right triplexer 2415 and 2417, respectively. Port 1 of the left and right triplexer 2415 and 2417 are each associated with the frequency range 1; port 2 of the left and right triplexer 2415 and 2417 are each associated with the frequency range 2; and port 3 of the left and right triplexer 2415 and 2417 are each associated with the frequency range 3. Each of the triplexers 2415 and 2417 includes three filters that are connected to ports 1, 2 and 3, each passing signals in the corresponding frequency range. The role of each filter is to pass signals with a frequency range within the port specification while rejecting other frequencies.

Alternatively, the triplexer may include a low pass filter with a steep upper side band rejection depending on the frequency range of the other two filters frequency ranges. The triplexer may also include a high pass filter with a steep lower side band rejection depending on the frequency range of the frequency ranges of the other two filters. The triplexer described herein may be designed in a variety of ways, and the illustrative embodiment in no way limits one of ordinary skill in the art from implementing alternative designs. For example, for the case with four or more mini PCIs, a switchplexer is used for the frequency multiplexing, together with four or more cables connected between the switchplexer and the four or more mini PCIs, respectively.

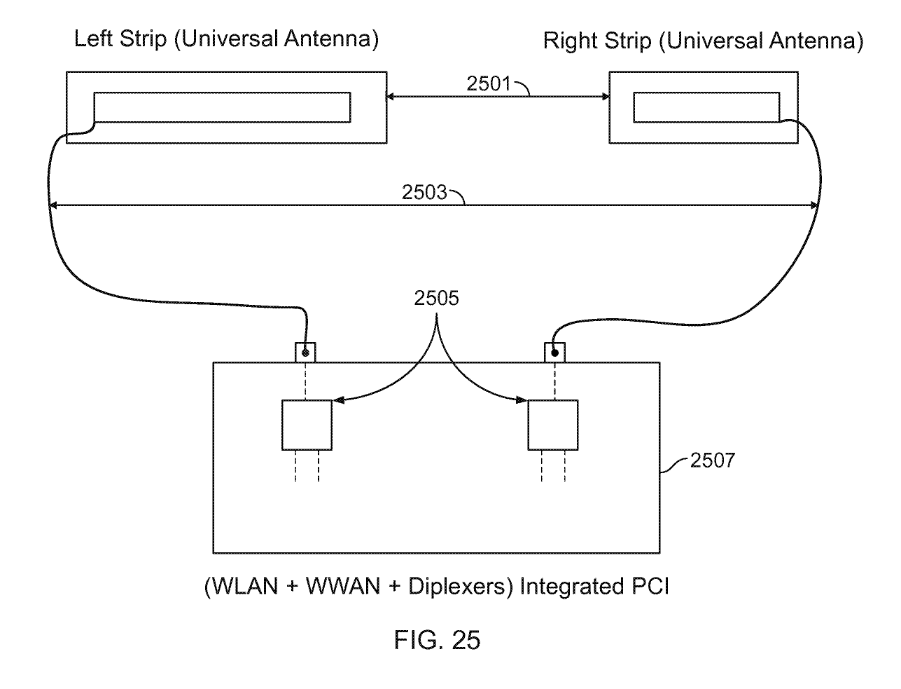

In addition, with the advent of a new type of PCI card that integrates WLAN and WWAN functions, the universal-antennas 2501, and single-cables 2503 configuration can be extended to integrate the diplexers (or triplexers or switchplexers) 2505 into the PCI card 2507, as shown in FIG. 25. This results in elimination of multiple cables connected between the diplexers (or triplexers or switchplexers) and the mini PCIs. The integration is achieved by using conventional FR-4 printed circuit boards, or other techniques such as thin film fabrication technique, system on chip (SOC) technique, low temperature co-fired ceramic (LTCC) technique, monolithic microwave integrated circuit (MMIC) technique, and the like.

While this document contains many specifics, these should not be construed as limitations on the scope of any invention or of what is claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features is described above as acting in certain combination can in some cases be exercised for the combination, and the claimed combination is directed to a subcombination or variation of a subcombination.

Particular implementations and embodiments have been described in this document. Variations and enhancements of the described implementations and embodiments, and other implementations and embodiments, can be made based on what is described and illustrated in this document.

1. A wireless communication system, comprising:
a first peripheral component interface (PCI) card for wireless communications in a first radio frequency (RF) frequency band;
a second PCI card for wireless communications in a second RF frequency band different from the first RF frequency band;
an antenna structured to operate at the first and second RF frequency bands;
a signal router coupled between the antenna and the first and second PCI cards to direct a communication signal from the antenna in the first RF frequency band to the first PCI card and a communication signal from the antenna in the second RF frequency band to the second PCI card, and to direct a communication signal from the first PCI card in the first RF frequency band to the antenna and a communication signal from the second PCI card in the second RF frequency band to the antenna; and
a single cable connected between the antenna and signal router to transmit communication signals in both the first and second RF frequency bands between the antenna and the signal router.

2. The system as in claim 1, wherein:
the antenna includes a composite left and right handed metamaterial structure.

3. The system as in claim 1, wherein:
the signal router includes a metamaterial structure.

4. The system as in claim 1, wherein:
the first PCT card is a wireless local area network (WLAN) PCI card and the second PCI card is a wireless wide area network (WWAN) PCI card.

5. The system as in claim 1, wherein:
the signal router is a diplexer operating at the first and second RF frequency bands.

6. The system as in claim 1, comprising:
a second antenna structured to operate at the first and second RF frequency bands;
a second signal router coupled between the second antenna and the first and second PCI cards to direct a communication signal from the second antenna in the first RF frequency band to the first PCI card and a communication signal from the second antenna in the second RF frequency band to the second PCI card; and
a second single cable connected between the second antenna and the signal router to transmit communication signals in both the first and second RF frequency bands between the antenna and the signal router.

7. The system as in claim 6, comprising:
a first cable connected between the signal router and the first PCI card to transmit communication signals between the signal router and the first PCI card;
a second cable connected between the signal router and the second PCI card to transmit communication signals between the signal router and the second PCI card;
a third cable connected between the second signal router and the first PCI card to transmit communication signals between the second signal router and the first PCI card; and
a fourth cable connected between the second signal router and the second PCI card to transmit communication signals between the second signal router and the second PCI card.

8. The system as in claim 6, comprising:
a third PCI card for wireless communications in a third RF frequency band different from the first and second RF frequency bands;
wherein the first and second antennas are structured to operate in the third RF frequency band, the signal router directs a communication signal from the antenna in the third RF frequency band to the third PCI card and to direct a communication signal from the third PCI card in the third RF frequency band to the antenna, and the second signal router directs a communication signal from the second antenna in the third RF frequency band to the third PCI card.

9. The system as in claim 1, wherein:
the signal router, the second signal router, the first PCI card and the second PCI card are integrated into an integrated circuit device that are connected to the antenna via the single cable and the second antenna via the second single cable.

10. The system as in claim 1, wherein:
the antenna is a metamaterial antenna comprising:
a substrate;
an antenna metallization layer formed on the substrate and patterned to include:
a conductive cell patch,
a conductive ground patch separated from the conductive cell patch connected to provide electrical ground for the metamaterial antenna,
a conductive meander line that connects the conductive cell patch and the conductive ground patch,
a conductive middle patch spaced from the conductive cell patch by a gap and capacitively coupled to the conductive cell patch through the gap,
a spiral conductive patch spaced from the conductive middle patch by a gap and capacitively coupled to the conductive middle patch through the gap, an inner conductive line connected to the spiral conductive patch; and
an outer conductive meander line having a first end connected to the spiral conductive patch and a second end connected to the conductive middle patch, the outer conductive meander line having a meander line portion that surrounds at least a portion of the inner conductive line.

11. The system as in claim 10, wherein:
the single cable is connected to the conductive middle patch to direct a communication signal to the antenna or receive a communication signal from the antenna.

12. The system as in claim 1, wherein:
the antenna is a metamaterial antenna comprising:
a substrate;
a first metallization layer formed on a first side of the substrate and patterned to include first metamaterial antenna elements;
a second metallization layer formed on a second side of the substrate opposing the first side and patterned to include second metamaterial antenna elements; and
a conductive via in the substrate to connect one of the first metamaterial antenna elements to one of the second metamaterial antenna elements,
wherein the first and second metamaterial antenna elements collectively to provide antenna operations at the first and second RF frequency bands.

13. An antenna system, which is configured to be coupled to first and second peripheral component interface (PCI) cards in a computer, comprising:
an antenna;
first, second, and third cables; and
a diplexer;
wherein the first cable couples the antenna and the diplexer, the second cable couples the diplexer and the first PCI card, and the third cable couples the diplexer and the second PCI card.

14. The antenna system as in claim 13, wherein the antenna comprises a metamaterial.

15. The antenna system as in claim 14, wherein the antenna is a single layer universal antenna structured to support multiple resonance frequencies.

16. The antenna system as in claim 14, wherein the antenna is a multi layer universal antenna structured to support multiple resonance frequencies.

17. The antenna system as in claim 13, wherein the diplexer comprises a metamaterial.

18. An antenna system, which is configured to be coupled to three or more peripheral component interface (PCI) cards in a computer, comprising:
an antenna;
a switchplexer;
a main cable coupling the antenna and the switchplexer; and
three or more secondary cables, each coupling the switchplexer and each of the three or more PCI cards,
wherein the antenna operates for three or more frequency ranges corresponding to applications associated with the three or more PCI cards, respectively, and the three or more secondary cables carry signals for the three or more frequency ranges, respectively.

19. The antenna system as in claim 18, wherein the antenna comprises a metamaterial.

20. The antenna system as in claim 19, wherein the antenna is a single layer universal antenna structured to support multiple resonance frequencies.

21. The antenna system as in claim 19, wherein the antenna is a multi layer universal antenna structured to support multiple resonance frequencies.

22. The antenna system as in claim 18, wherein the switchplexer comprises a metamaterial.

23. An antenna system, which is configured to be coupled to a peripheral component interface (PCI) wherein wireless wide area network (WWAN) and wireless local area network (WLAN) functions are integrated, comprising:
an antenna that operates for a first frequency range associated with WLAN applications and a second frequency range associated with WWAN applications;
a cable; and
a diplexer;
wherein the cable couples the antenna and the diplexer, which is integrated in the PCI.

24. The antenna system as in claim 23, wherein the antenna comprises a metamaterial.

25. The antenna system as in claim 24, wherein the antenna is a single layer universal antenna structured to support multiple resonance frequencies.

26. The antenna system as in claim 24, wherein the antenna is a multi layer universal antenna structured to support multiple resonance frequencies.

27. The antenna system as in claim 23, wherein the diplexer comprises a metamaterial.
